(19) United States
(12) Patent Application Publication
(10) Pub. No.: US 2022/0171052 A1
(43) Pub. Date: Jun. 2, 2022

(54) RADAR SYSTEM AND IMAGING METHOD

(71) Applicant: NEC Corporation, Minato-ku, Tokyo (JP)

(72) Inventors: Kazumine OGURA, Tokyo (JP); Tatsuya SUMIYA, Tokyo (JP); Masayuki ARIYOSHI, Tokyo (JP); Taichi TANAKA, Tokyo (JP); Daisuke IKEFUJI, Tokyo (JP)

(73) Assignee: NEC Corporation, Minato-ku, Tokyo (JP)

(21) Appl. No.: 17/618,172

(22) PCT Filed: Jun. 18, 2019
(86) PCT No.: PCT/JP2019/024142

§ 371 Date: Dec. 10, 2021

(51) Int. Cl. G01S 13/89; G01S 7/41

(52) U.S. Cl. CPC G01S 13/89; G01S 7/412

(57) ABSTRACT

A radar system includes a measurement policy control unit that determines a measurement policy relating to how a signal is to be measured, a transmitting antenna that irradiates electromagnetic waves according to the measurement policy, a receiving antenna that receives reflected waves of the irradiated electromagnetic waves and generates a measurement signal, a storage unit that stores the measurement signals, a window control unit that determines a window for selecting the measurement signals, a signal selection unit that selects measurement signals from the storage unit based on the window, and an image generating unit that generates a radar image from the selected measurement signals.

### TECHNICAL FIELD

The present invention relates to a radar system, an imaging method, and an imaging program that perform receiving electromagnetic waves reflected by an object and imaging.

### BACKGROUND ART

A body scanner system, as illustrated in FIG. 32, has been introduced in airports and the like. In the body scanner system, an electromagnetic wave such as a millimeter wave is irradiated to an object (such as a human body) 800 that stops within an area 802. A plurality of radars 804 (including a transmitting antenna and a receiving antenna) are installed on a side panel 803. Electromagnetic waves reflected by the object 800 are measured, and visualization (imaging) is performed based on the measurement signals (refer to, for example, non-patent literature 1). Based on the images (radar images), for example, an inspection is performed to determine whether the object 800 possesses a suspicious object or not.

Non-patent literature 2 describes a method for measuring velocity of an object in an image by estimating an optical flow between image frames. Non-patent literature 3 describes a method (Iterative Closest Point: ICP) for estimating a position and an orientation of an object by superimposing two images.

### CITATION LIST

### Non Patent Literature

NPL 1: D. M. Sheen, et al., “Three-Dimensional Millimeter-Wave Imaging for Concealed Weapon Detection,” IEEE Transactions on Microwave Theory and Techniques, vol. 49, No. 9, September 2001
NPL 2: B. D. Lucas, T. Kanade, “An iterative image registration technique with an application to stereo vision,” Proc. 7th International Joint Conference on Artificial Intelligence, pp. 674-679, 1981
NPL 3: S. Rusinkiewicz, M. Levoy, “Efficient Variants of the ICP Algorithm,” Proc. 3rd International Conference on 3-D Digital Imaging and Modeling, pp. 145-152, 2001

### SUMMARY OF INVENTION

### Technical Problem

FIG. 33 is a block diagram showing a configuration example of a general radar system. The radar system 901 shown in FIG. 33 includes a transmitting antenna 902 that emits an electromagnetic wave, a receiving antenna 903 that receives a reflected electromagnetic wave, a signal transmitting and receiving unit 904, and an image generating unit 905. The transmitting antenna 902 and the receiving antenna 903 correspond to the radar 804 in FIG. 32. Although a single transmitting antenna 902 and a single receiving antenna 903 are illustrated in FIG. 33, in practice, a large number of transmitting antennas 902 and a large number of receiving antennas 903 are installed.

The signal transmitting and receiving unit 904 causes the transmitting antenna 902 to emit an electromagnetic wave. The signal transmitting and receiving unit 904 inputs a measurement signal from the receiving antenna 903. The image generating unit 905 generates a radar image based on the measurement signal.

The transmitting antenna 902 and the receiving antenna 903 form an electronically scanned array. The number of pairs of a transmitting antenna and a receiving antenna in the electronically scanned array is denoted by H, and the signals (radar signals) obtained by all antenna pairs are denoted by S₁, S₂, . . . , S_{H}. FIG. 34 is an explanatory diagram showing an example of a radar signal and a radar image. As shown in FIG. 34, the image generating unit 905 generates a radar image for each section by using the signals of all antenna pairs obtained in each section (section #1, section #2, and section #3).

FIG. 35 is an explanatory diagram showing each position of an object 800 during its movement. In the body scanner system shown in FIG. 32, when the object 800 is inspected while walking along the passage 801 without stopping in the area 802, the image #1, the image #2, and the image #3 shown in FIG. 34 correspond to the results measured at the position #1, the position #2, and the position #3 shown in FIG. 35. However, if the shape of the detection target 805 (for example, a suspicious object) is observable only at the intermediate point between the positions #1 and #2, it is difficult to detect the detection target 805 by the radar image.

An imaging device such as a typical body scanner that applies electromagnetic waves is intended to image a stationary object 800. Therefore, the imaging device does not generate radar images using signals spanning the first measurement and the second measurement. In other words, since the measurement time is different between the measurement signals of all the transmitting and receiving antenna pairs in the first measurement (corresponding to the section #1 in FIG. 34) and the measurement signals of all the transmitting and receiving antenna pairs in the second measurement (corresponding to the section #2 in FIG. 34), the time interval for generating the radar image is long (the frame rate is low). As a result, as illustrated in FIG. 35, when the object 800 moves, detection omissions of the detection target 805 occurs. In FIG. 35, the object indicated by the dashed line is the radar image (actually, it is not imaged) that causes the detection omissions.

Since simply increasing a frame rate for generating the radar image increases the number of imaging processes, the amount of computation in the radar system 901 is increased.

In the case where a plurality of transmitting antennas 902 are used, if electromagnetic waves having close frequencies are irradiated to the object 800 at the same time, they cause interference with each other. Therefore, the plurality of transmitting antennas 902 cannot irradiate the electromagnetic waves at the same time. For this reason, when the object 800 moves, blur (image blur) may occur and the detection target 805 may be buried in the radar image.

Further, if the order of electromagnetic radiation of the plurality of transmitting antennas 902 is not changed during operation of the radar system 901, Blur may occur due to imaging using signals measured in a particular order, and the detection target 805 may be buried in the radar image.

It is an object of the present invention to provide a radar system, an imaging method and an imaging program which can increase a frame rate without increasing a computational amount and can suppress occurrence of blur.

### Solution to Problem

A radar system according to the present invention includes measurement policy control means for determining a measurement policy relating to how a signal is to be measured, a transmitting antenna that irradiates electromagnetic waves according to the measurement policy, a receiving antenna that receives reflected waves of the irradiated electromagnetic waves and generates a measurement signal, storage means for storing the measurement signals, window control means for determining a window for selecting the measurement signals, signal selection means for selecting measurement signals from the storage means based on the window, and image generating means for generating a radar image from the selected measurement signals.

Another radar system according to the present invention includes measurement policy control means for determining a measurement policy relating to how a signal is to be measured, a transmitting antenna that irradiates electromagnetic waves according to the measurement policy, a receiving antenna that receives reflected waves of the irradiated electromagnetic waves and generates a measurement signal, image generating means for generating a radar image from the measurement signals, storage means for storing the radar images, window control means for determining a window for selecting the radar image, and image updating means for selecting the radar image from the storage means based on the window and generating an updated radar image based on the selected radar image.

An imaging method according to the present invention includes determining a measurement policy relating to how a signal is to be measured, irradiating electromagnetic waves from a transmitting antenna according to the measurement policy, receiving reflected waves of the irradiated electromagnetic waves by a receiving antenna and generating a measurement signal, storing the measurement signal in storage means, determining a window for selecting the measurement signals, selecting measurement signals from the storage means based on the window, and generating a radar image from the selected measurement signals.

Another imaging method according to the present invention includes determining a measurement policy relating to how a signal is to be measured, irradiating electromagnetic waves from a transmitting antenna according to the measurement policy, receiving reflected waves of the irradiated electromagnetic waves by a receiving antenna and generating a measurement signal, generating a radar image from the measurement signals, storing the radar image in storage means, determining a window for selecting the radar image, and selecting the radar image from the storage means based on the window and generating an updated radar image based on the selected radar image.

An imaging program according to the present invention causes a computer to execute a process of determining a measurement policy relating to how a signal is to be measured, a process of generating a measurement signal based on reflected waves of irradiated electromagnetic waves irradiated according to the measurement policy, a process of storing the measurement signal in storage means, a process of determining a window for selecting the measurement signals, a process of selecting measurement signals from the storage means based on the window, and a process of generating a radar image from the selected measurement signals.

Another imaging program according to the present invention causes a computer to execute a process of determining a measurement policy relating to how a signal is to be measured, a process of generating a measurement signal based on reflected waves of irradiated electromagnetic waves irradiated according to the measurement policy, a process of generating a radar image from the measurement signals, a process of storing the radar image in storage means, a process of determining a window for selecting the radar image, and a process of selecting the radar image from the storage means based on the window and generating an updated radar image based on the selected radar image.

### Advantageous Effects of Invention

According to the present invention, the frame rate can be increased without increasing the amount of computation and the occurrence of blur can be suppressed.

### BRIEF DESCRIPTION OF DRAWINGS

FIG. 1 It depicts a block diagram showing a configuration example of a radar system of the first example embodiment.

FIG. 2A It depicts a block diagram showing a configuration example of an electronically scanned array.

FIG. 2B It depicts a block diagram showing a configuration example of an electronically scanned array.

FIG. 2C It depicts a block diagram showing a configuration example of an electronically scanned array.

FIG. 3 It depicts an explanatory diagram for explaining an irradiation time interval in a measurement policy.

FIG. 4 It depicts an explanatory diagram for explaining group information of the transmitting antenna in a measurement policy.

FIG. 5 It depicts an explanatory diagram for explaining handling of measurement signals in group units.

FIG. 6 It depicts an explanatory diagram for explaining an order of irradiation in a measurement policy.

FIG. 7 It depicts an explanatory diagram for explaining a signal irradiated by a transmitting antenna.

FIG. 8 It depicts an explanatory diagram showing an example of a signal selection method based on a window size and a degree of overlap in the first example embodiment.

FIG. 9 It depicts an explanatory diagram showing an example of an imaging method.

FIG. 10 It depicts an explanatory diagram showing a schematic operation of a radar system of the first example embodiment.

FIG. 11 It depicts a flowchart showing an operation of a radar system of the first example embodiment.

FIG. 12 It depicts a block diagram showing a configuration example of a radar system of the second example embodiment.

FIG. 13 It depicts an explanatory diagram showing a relationship between a measurement signal and a generated radar image in the second example embodiment.

FIG. 14 It depicts an explanatory diagram showing an example of a signal selection method based on a window size and a degree of overlap in the second example embodiment.

FIG. 15 It depicts a flowchart showing an operation of a radar system of the second example embodiment.

FIG. 16 It depicts a block diagram showing a configuration example of a radar system of the third example embodiment.

FIG. 17 It depicts an explanatory diagram for explaining an irradiation order based on a position of an object.

FIG. 18 It depicts an explanatory diagram for explaining a window size selection method based on a position of an object.

FIG. 19 It depicts an explanatory diagram for explaining a window size selection method based on speed of an object.

FIG. 20 It depicts an explanatory diagram for explaining a window size selection method based on a position and speed of an object.

FIG. 21 It depicts an explanatory diagram showing a coordinate system of a radar and an image.

FIG. 22 It depicts a flowchart showing an operation of a radar system of the third example embodiment.

FIG. 23 It depicts a block diagram showing a configuration example of a radar system of the fourth example embodiment.

FIG. 24 It depicts a flowchart showing an operation of a radar system of the fourth example embodiment.

FIG. 25 It depicts a block diagram showing a configuration example of a radar system of the fifth example embodiment.

FIG. 26A It depicts a flowchart showing an operation of a radar system of the fifth example embodiment.

FIG. 26B It depicts a flowchart showing an operation of a radar system of the fifth example embodiment.

FIG. 27 It depicts a block diagram showing a configuration example of a radar system of the sixth example embodiment.

FIG. 28A It depicts a flowchart showing an operation of a radar system of the sixth example embodiment.

FIG. 28B It depicts a flowchart showing an operation of a radar system of the sixth example embodiment.

FIG. 29 It depicts a block diagram showing an example of a computer with a CPU.

FIG. 30 It depicts a block diagram of a main part of a radar system.

FIG. 31 It depicts a block diagram of a main part of another aspect of a radar system. Block diagram of the main part of another type of radar system.

FIG. 32 It depicts an explanatory diagram showing a body scanner system.

FIG. 33 It depicts a block diagram showing a configuration example of a general radar system.

FIG. 34 It depicts an explanatory diagram showing an example of a radar signal and a radar image.

FIG. 35 It depicts an explanatory diagram showing each position of an object during its movement.

### DESCRIPTION OF EMBODIMENTS

Hereinafter, the example embodiment of the present invention is described with reference to the drawings.

### Example Embodiment 1

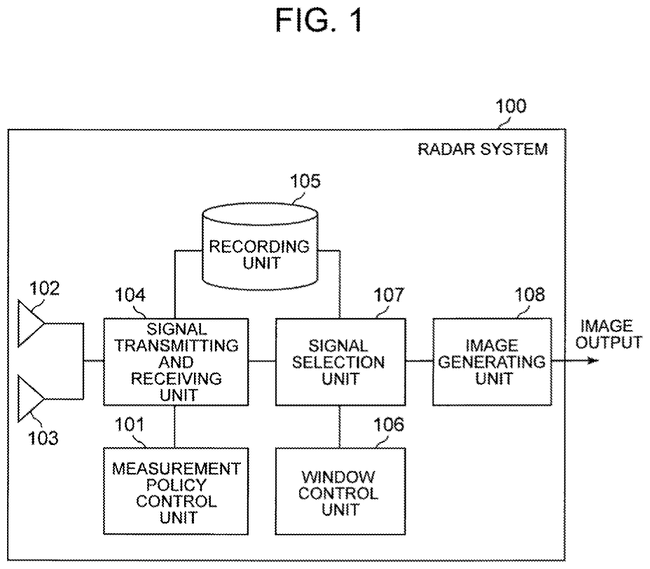

FIG. 1 is a block diagram showing a configuration example of a radar system of the first example embodiment. The radar system 100 of the first example embodiment includes a measurement policy control unit 101 that determines a measurement policy representing a measurement method by antennas, a transmitting antenna 102, a receiving antenna 103, a signal transmitting and receiving unit 104 that instructs the transmitting antenna 102 and the receiving antenna 103 to transmit and receive electromagnetic waves based on the measurement policy, a recording unit 105 that stores the measurement signals, a window control unit 106 that determines a window for selecting the measurement signals, a signal selection unit 107 that selects the measurement signals stored in the recording unit 105, and an image generating unit 108 that generates a radar image from the measurement signals.

Although a single transmitting antenna 102 and a single receiving antenna 103 are illustrated in FIG. 1, the radar system 100 includes a plurality of transmitting antennas and a plurality of receiving antennas.

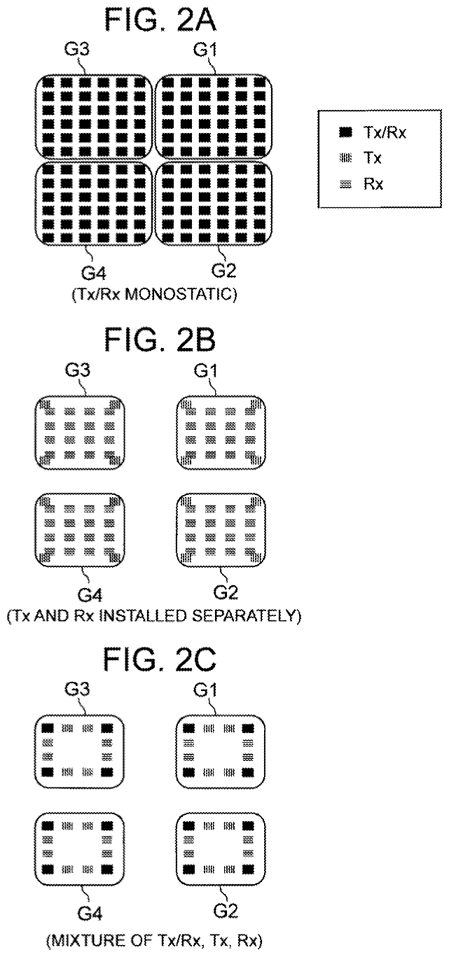

First, an example configuration of a transmitting antenna and a receiving antenna is described. FIG. 2A to FIG. 2C are block diagrams showing a configuration example of an electronically scanned array including a plurality of transmitting antennas and a plurality of receiving antennas.

In the example shown in FIG. 2A, the electronically scanned array including the transmit and receiving antennas comprises one or more monostatic transmitting and receiving antenna elements.

In the example shown in FIG. 2B, the electronically scanned array comprises a bistatic radar. Each antenna element performs either transmission or reception. The electronically scanned array may comprise a multi-static antenna in which one or more other receiving antennas receive a signal irradiated by a particular transmitting antenna. The electronically scanned array may also comprise Multiple-Input and Multiple-Output (MIMO) in which multiple transmitting antennas transmit signals of the same frequency.

In the example shown in FIG. 2C, the electronically scanned array comprises a mixture of antenna elements that only receive or transmit and antenna elements that transmit and receive.

In each example embodiment, any of the electronically scanned arrays illustrated in FIGS. 2A to 2C can be used as an electronically scanned array including a plurality of transmitting antennas and a plurality of receiving antennas or a plurality of transmitting and receiving antennas. For convenience, the following description assumes a configuration in which the transmit and receiving antennas are installed separately, but the transmitting and receiving antennas may be integrated into a transmitting and receiving antenna element (refer to FIG. 2C).

The measurement policy is a policy on how the radar system measures signals. In this example embodiment, the measurement policy includes, for example, an irradiation time interval which is a time interval at which the transmitting antenna irradiates electromagnetic waves, group information of the transmitting antennas, and an irradiation order. All of the irradiation time interval, the group information of the transmitting antennas, and the irradiation order may be used as the measurement policy, or any one or two of them may be used.

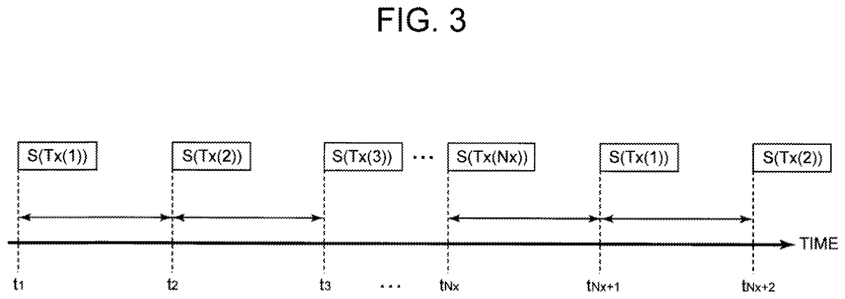

FIG. 3 is an explanatory diagram for explaining an irradiation time interval in a measurement policy. In FIG. 3, S(Tx(1)) represents a measurement signal for the irradiation of the transmitting antenna Tx(1) whose irradiation order is the first. S(Tx(Nx)) is a measurement signal for the irradiation of the transmitting antenna Tx(Nx) whose irradiation order is the Nxth. The total number of transmitting antennas is Nx. When multiple receiving antennas receive the reflected wave of the irradiation by the transmitting antenna, for example, S(Tx(1)) is a signal measured by all receiving antennas that received the reflected wave of the signal irradiated by Tx(1).

In FIG. 3, t1, t2, t3, . . . , tNx+2 indicate the start time of electromagnetic wave irradiation of each transmitting antenna. The irradiation time interval is the time of the difference between to and t(n+1) (n=1, . . . , Nx+2 in the example shown in FIG. 3). The irradiation time interval is, for example, an equal interval. Hereafter, the irradiation time interval may be expressed as I.

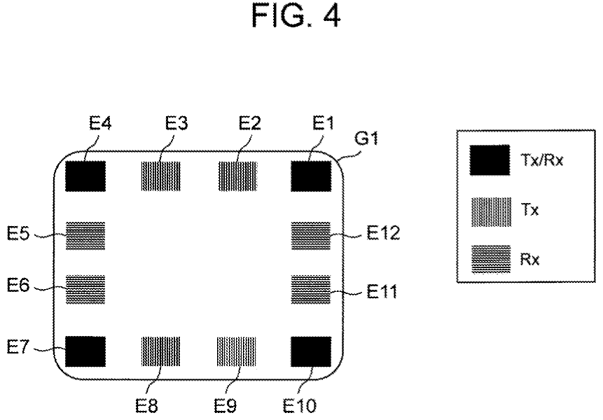

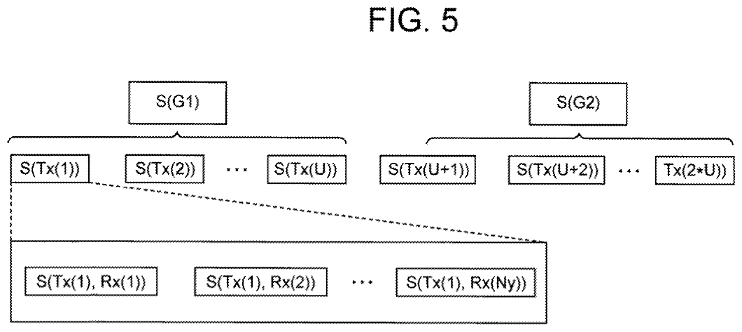

FIG. 4 and FIG. 5 are explanatory diagrams for explaining group information of the transmitting antenna in a measurement policy. Referring to FIGS. 4 and 5, and FIG. 2, the group information of the transmitting antenna is described.

In FIG. 2, each of G1 to G4 corresponds to an example of a group of transmitting antennas in an electronically scanned array. That is, FIG. 2 illustrates an example of how to divide the groups of transmitting antennas. Each group includes one or more transmitting antennas. The signal transmitting and receiving unit 104, for example, divides antennas into groups so that the number of transmitting antennas in each group is the same.

As an example, the measurement policy control unit 101 groups a plurality of transmitting antennas based on the position between each of the transmitting antennas. For example, the measurement policy control unit 101 groups a plurality of transmitting antennas so that antennas close to each other are included in one group. The measurement policy control unit 101 may configure the group with transmitting antennas that are located in the same column (or row) relative to the two-dimensional electronically scanned array. The measurement policy control unit 101 may also configure the group so that no grating lobe occurs in the radar image generated based on the signals of the transmitting antennas belonging to one group.

In this example embodiment, the group information of the transmitting antenna includes the group number (G1, G2, G3, G4) and the antenna number belonging to the group.

FIG. 4 shows an enlarged example of group G1 shown in FIG. 2C. The group information of the transmitting antenna of group G1 illustrated in FIG. 4 is as follows.

G1={E1,E2,E3,E4,E7,E8,E9,E10} (1)

In the present and other example embodiments, measurement signals are handled in group units. FIG. 5 is an explanatory diagram for explaining handling of measurement signals in group units. The number of transmitting antennas of each group in FIG. 5 is U. S(G1) and S(G2) denote the measurement signals of group G1 and group G2, respectively. S(G1) includes the measurement signals S(Tx(1)) to S(Tx(U)) of U transmitting antennas from Tx(1) to Tx(U). When Ny receiving antennas measure irradiation signals of the transmitting antennas, the measurement signal S(Tx(1)) includes the signals S(Tx(1), Rx(1)) to S(Tx(1), Rx(Ny)) measured by the receiving antennas Rx(1) to Rx(Ny).

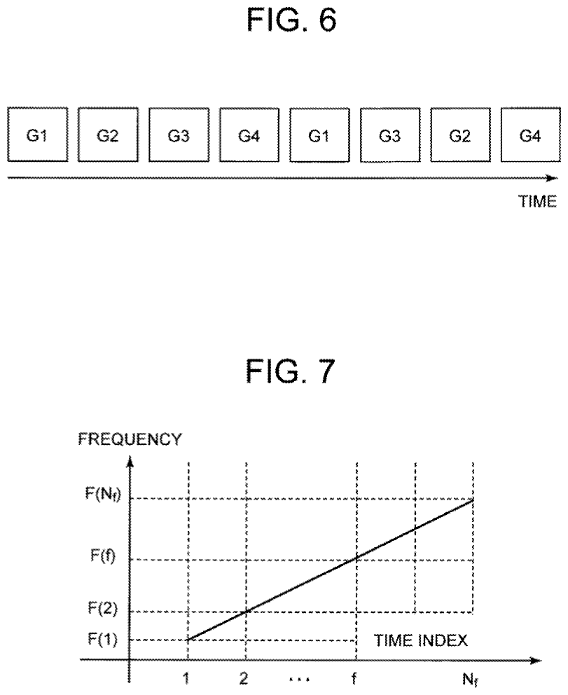

FIG. 6 is an explanatory diagram for explaining an order of irradiation in a measurement policy. FIG. 6 shows an example in which the irradiation order of each group is changed as time passes. In the example shown in FIG. 6, first, electromagnetic waves are irradiated from the transmitting antennas in the order of groups G1, G2, G3, and G4, and then the irradiation order is changed so that electromagnetic waves are irradiated from the transmitting antennas in the order of groups G1, G3, G2, and G4. In this case, the irradiation order is {G1, G2, G3, G4, G1, G3, G2, G4}. The measurement policy control unit 101 may determine the irradiation order by arranging all of all of the possible combinations of the plurality of groups. For example, using groups G1, G2, G3, and G4 as an example, the measurement policy control unit 101 obtains possible orders of G1, G2, G3, and G4 in advance, and arranges the groups comprising each of the all orders.

The measurement policy control unit 101 may determine the irradiation order based on the positions of the transmitting antennas constituting the groups. For example, the measurement policy control unit 101 may set the order such that the groups whose transmitting antenna positions are close to each other are successively irradiated. In addition, the measurement policy control unit 101 may randomly select the transmitting antennas to determine the irradiation order. The irradiation order may be a repetition of the order represented by the equation (2).

Order={G1,G2,G3,G4} (2)

The signal transmitting and receiving unit 104 inputs the measurement policy (irradiation time interval, group information of the transmitting antennas, and irradiation order) determined by the measurement policy control unit 101, and has the plurality of transmitting antennas irradiate electromagnetic waves according to the measurement policy.

For example, when the signal transmitting and receiving unit 104 inputs the measurement policy (irradiation time interval, group information of the transmitting antennas, and irradiation order) from the measurement policy control unit 101, the signal transmitting and receiving unit 104 outputs an irradiation instruction to the transmitting antenna 103 at the irradiation time. Then, the signal transmitting and receiving unit 104 receives the measurement signal from the receiving antenna 103 and outputs the measurement signal, the irradiation time, and the group information of the transmitting antenna to the recording unit 105. In addition, the signal transmitting and receiving unit 104 notifies the signal selecting unit 107 that the measurement signal has been stored in the recording unit 105.

If the arrangement of the groups in the irradiation order is finite, the signal transmitting and receiving unit 104 returns to the state in which the electromagnetic wave is irradiated from the transmitting antenna of the first group in the irradiation order when the irradiation of the electromagnetic wave from the transmitting antennas of all the groups is completed, so that the measurement may not be interrupted. Then, the signal transmitting and receiving unit 104 controls the transmitting antennas so that the electromagnetic waves are irradiated from the transmitting antennas according to the irradiation order again.

The order of irradiation of the transmitting antennas in each group is arbitrary. As an example, the plurality of transmitting antennas in a group irradiate electromagnetic waves in an order that follows the sequence order of the group information of the transmitting antennas (refer to equation (1)). In that case, Tx(1)=E1, Tx(2)=E2, Tx(3)=E3, Tx(4)=E4, Tx(5)=E7, Tx(6)=E8, Tx(7)=E9, and Tx(8)=E10.

The signal transmitting and receiving unit 104 calculates the irradiation time (irradiation start time) based on the irradiation time interval and the irradiation order. In the example shown in FIG. 3, the signal transmitting and receiving unit 104 calculates the irradiation times t2 and t3 based on the one previous irradiation time t1 and the irradiation time interval I (t2=t1+I, t3=t2+I, respectively). The signal transmitting and receiving unit 104 outputs an irradiation instruction to each of the transmitting antennas Tx(1), Tx(2), and Tx(3) at the irradiation times t1, t2, and t3. Then, the signal transmitting and receiving unit 104 obtains measurement signals S(Tx(1)), S(Tx(2)), and S(Tx(3)) through the receiving antennas.

When the transmitting antenna 102 receives an irradiation instruction from the signal transmitting and receiving unit 104, the transmitting antenna 102 starts irradiating electromagnetic waves. The electromagnetic waves irradiated by the transmitting antenna are, for example, Pulse Wave, Continuous Wave (CW), Frequency Modulated CW (FMCW), and Stepped FMCW. In the following, as the electromagnetic wave irradiated by the transmitting antenna, an FMCW whose frequency varies with time is assumed as shown in FIG. 7. Suppose that the time index is f and the frequency is denoted as F(f), where Nf is the time index at the maximum frequency.

Next, a window for controlling the number of selected measurement signals and the timing will be described. The window includes a window size and a degree of overlap. The window size corresponds to the number of measurement signals in the group to be selected. The degree of overlap is a value that specifies how many measurement signals are overlapped between the previously selected measurement signals and the measurement signals to be selected this time. The timing to select the next measurement signal is a value to be determined based on the timing of the previous selection of the measurement signal and the degree of overlap.

The measurement policy determination unit 101 divides the transmitting antennas into groups. When the number of groups is C, the window control unit 106 predetermines an integer satisfying the following equation (3) as the window size W.

1≤W≤C (3)

The window size may be a value that is directly input by the user through a graphical user interface (GUI) or the like. The window size may be calculated based on a resolution of the radar image. The resolution of the radar image is input from the GUI, for example. The higher the radar resolution, the larger the W.

The degree of overlap D is given in advance as an integer that satisfies the following equation (4).

0≤D≤W−1 (4)

The degree of overlap may be a value that is directly input by a user through a GUI or the like. The degree of overlap may also be calculated based on the processing time in the radar system. In that case, the measurement policy determining unit 101 makes D smaller the longer the processing time is.

The signal transmitting and receiving unit 104 performs the measurement in the irradiation order given by the measurement policy control unit 101. For example, the signal transmitting and receiving unit 104 receives the irradiation order from the measurement policy control unit 101 each time the measurement is completed, and performs the measurement according to the irradiation order.

When the signal selection unit 107 receives a notification from the signal transmitting and receiving unit 104 that a new measurement signal has been stored in the recording unit 105, the signal selection unit 107 selects measurement signals from the recording unit 105 based on a window (window size W and degree of overlap D), which is an input from the window control unit 106. The signal selection unit 107 outputs the selected measurement signals to the image generating unit 108. The signal selection unit 107 determines the timing for selecting the measurement signal according to the degree of overlap D. The timing to select the measurement signals is the timing when (W-D) measurement signals are newly stored from the previous selection timing. In addition, the signal selection unit 107 determines the number of measurement signals to be selected according to the window size W.

The signal selection unit 107 receives a notification from the signal transmitting and receiving unit 104, and when it is time to select measurement signals, the signal selection unit 107 selects measurement signals for the window size (W) with the most recent measurement time from the recording unit 105.

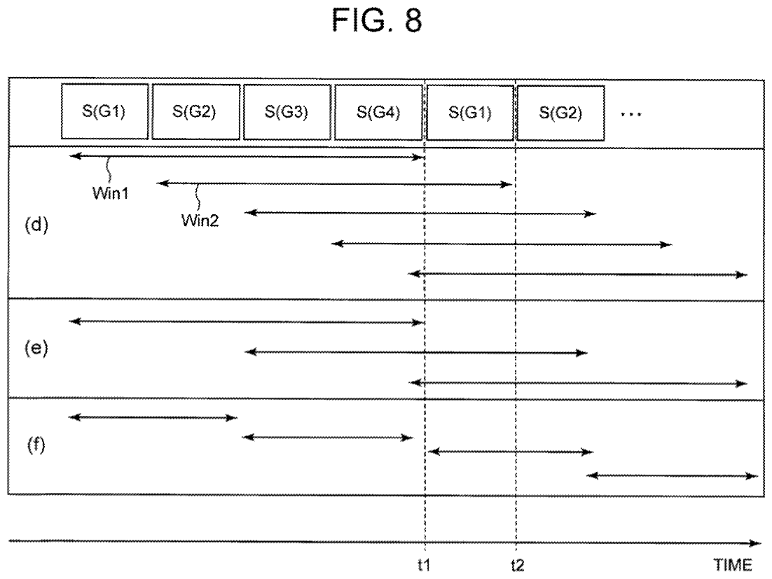

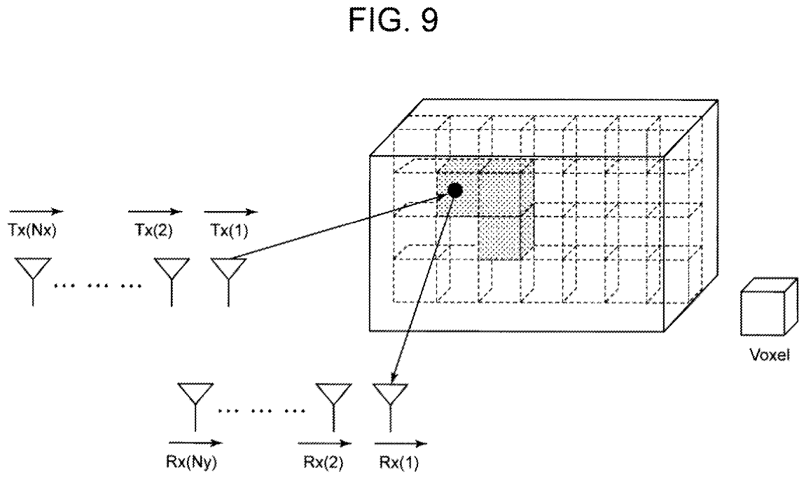

FIG. 8 is an explanatory diagram showing an example of a signal selection method based on the window size and the degree of overlap. In the example shown in FIG. 8, the number of groups is 4. The irradiation order is assumed to follow equation (2). In FIG. 8, (d) shows windows Win1 and Win2 when W=4 and D=3. The signal selection unit 107 selects the measurement signals S(G1), S(G2), S(G3), and S(G4) based on the window Win1 at the timing of time t1. Since (W-D)=1, the signal selection unit 107 selects the measurement signals S(G2), S(G3), S(G4), and S(G1) based on the window Win2 at the timing of time t2 when the new measurement signal S(G1) is stored in the recording unit 105.

In FIG. 8, (e) shows the window when W=4 and D=2. In FIG. 8, (f) shows windows when W=2 and D=0. If the irradiation order is not regular as illustrated in FIG. 6, and there are measurement signals of the same group among the selected measurement signals, the signal selection unit 107 selects only the measurement signal with a new measurement time.

The image generating unit 108 generates and outputs a radar image using a known imaging method with the measurement signal selected by the signal selecting unit 107 as an input. For example, Beamforming, Factorized Beamforming, and w-k are known as imaging methods.

FIG. 9 is an explanatory diagram showing an example of an imaging method by Beamforming. In FIG. 9, Vector(Tx(1)) indicates the position of the transmitting antenna 102 corresponding to Tx(1). Vector(Rx(1)) indicates the position of the receiving antenna 103 corresponding to Rx(1). Vector(Rx(1)) indicates the position of the receiving antenna 103 corresponding to Rx(1). The radar image A (Vector(v)) produced by imaging is calculated by the following equation (5), where Vector(v) refers to the position of the imaging voxel v. In the figure, vectors are represented with arrows. In this specification, vectors are represented as Vector(*). That is, Vector(*) is synonymous with “*” with an arrow.

$$\begin{matrix} [ Math . 1 ] & \\ A ( \vec{v} ) = {\sum }_{i ∈ \{ {G}_{1} , {G}_{2} , ⋯ {G}_{W} \}} {\sum }_{y = 1}^{{N}_{y}} {\sum }_{f = 1}^{{N}_{f}} ( S ( i , y , f ) \cdot {e}^{\frac{2 π j \cdot F ( f )}{c} R ( \vec{v} , i , y )} ) & ( 5 )\end{matrix}$$

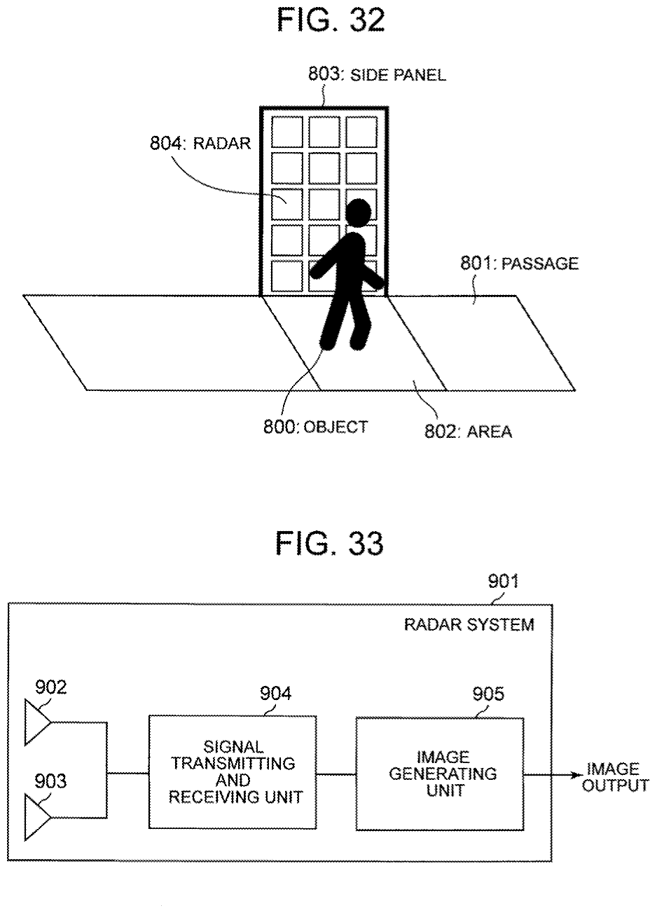

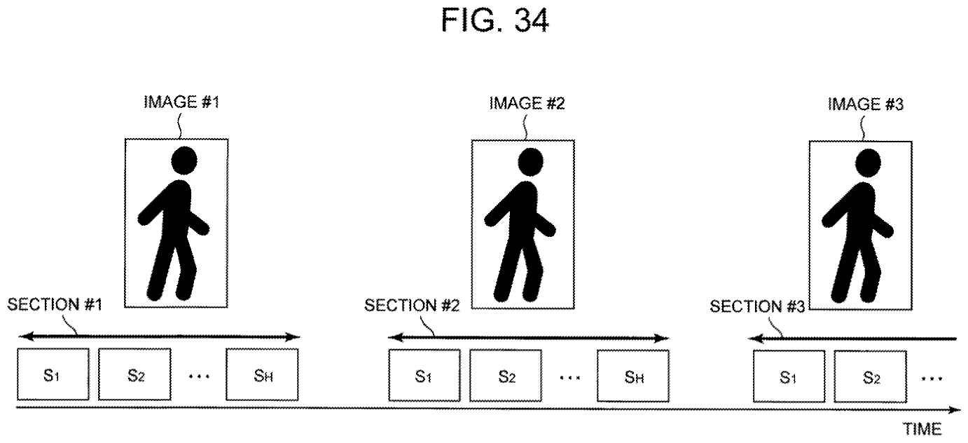

In equation (5), S(i,y,f) denotes the measured signal of frequency F(f) at the receiving antenna Rx(y) based on the electromagnetic wave reflected by the object 800 (refer to FIG. 32) or the like when the electromagnetic wave is irradiated from the transmitting antenna Tx(i) belonging to the groups G1 to Gw. Nf denotes the number of frequencies of the irradiated electromagnetic wave. j is an imaginary number. c denotes the speed of light. R(Vector(v),i,y) is a sum of a distance from the transmitting antenna Tx(i) to the location of the imaging voxel and a distance from the receiving antenna Rx(y) to the location of the imaging voxel, and is expressed by the following equation (6).

[Math. 2]

R(\vec{v},i,y)=|\vec{Tx(l)}−\vec{v}|+|\vec{Rx(y)}−\vec{v}| (6)

In the radar system of this example embodiment, radar signals are continuously measured based on a predetermined measurement policy, and imaging is performed based on the selected measurement signals according to a predetermined window size and degree of overlap. Such a process is executed to obtain a continuous image with a high frame rate.

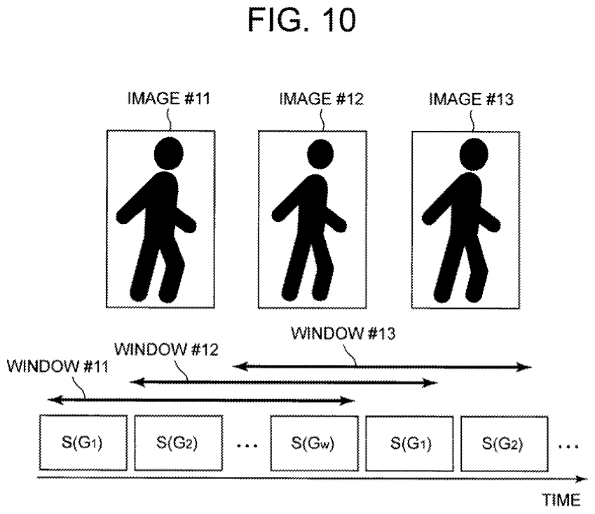

FIG. 10 is an explanatory diagram showing a schematic operation of the radar system 100 of the first example embodiment. In the example shown in FIG. 10, measurement signals (S(G1), S(G2), . . . , S(Gw)) are selected by the image generating unit 108 in the window #11, and the image #11 is generated. In the window #12, the measurement signals (S(G2), S(G3), . . . , S(Gw), S(G1)) are selected and the image #12 is generated. In the window #13, the measurement signals ( . . . , S(Gw), S(G1), S(G2)) are selected and the image #13 is generated.

The image output from the image generator 108 is displayed as a radar image on a display, for example. Further, it is possible to perform object detection and the like from the radar image.

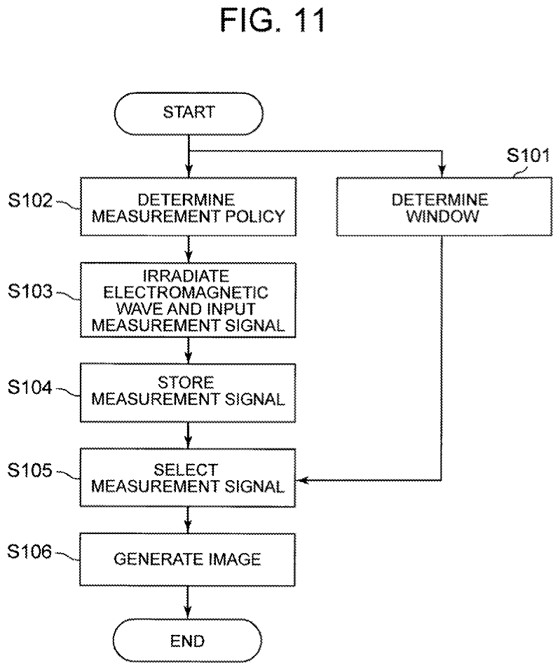

Next, with reference to the flowchart of FIG. 11, the operation of the radar system 100 will be described.

The window control unit 106 determines a window (step S101). The window control unit 106 determines a window size W satisfying the above equation (3), and determines a degree of overlap D satisfying the above equation (4), for example.

The measurement policy control unit 101 determines the measurement policy (step S102). That is, the measurement policy control unit 101 determines the measurement policy (irradiation time interval, group information of the transmitting antenna, and irradiation order) as described above. Then, the measurement policy control unit 101 outputs the determined measurement policy to the signal transmitting and receiving unit 104.

The window control (the process of step S101) may be performed after the process of step S102.

The signal transmitting and receiving unit 104 outputs an irradiation instruction to each of the transmitting antennas 102 according to an irradiation order at an irradiation time interval in the measurement policy input from the measurement policy control unit 101. The transmitting antenna 102 irradiates an electromagnetic wave whose frequency changes according to the passage of time as illustrated in FIG. 7, for example (step S103). The receiving antenna 103 receives the reflected wave of the electromagnetic wave irradiated by the transmitting antenna 102, and outputs the obtained signal (measurement signal) to the signal transmitting and receiving unit 104. The signal transmitting and receiving unit 104 inputs the measurement signal (step S103). The signal measurement process (the process of step S103) is repeatedly executed.

The signal transmitting and receiving unit 104 stores the measurement signal, the measurement time, and the group information for each group (for each group number) in the recording unit 105 (step S104). For example, the signal transmitting and receiving unit 104 stores the measurement signals for each group (by group number) in the recording unit 105, such as S(G1) (measurement signal of group G1) and S(G2) (measurement signal of group G2) illustrated in FIG. 5. In addition, the signal transmitting and receiving unit 104 notifies the signal selecting unit 107 that a new measurement signal has been stored.

When the signal selection unit 107 receives a notification from the signal transmitting and receiving unit 104 that a new measurement signal has been stored in the recording unit 105, the signal selection unit 107 selects measurement signals from the recording unit 106 based on a window (window size and degree of overlap), which is an input from the window control unit 106 (step S105). The signal selection unit 107 outputs the selected measurement signals to the image generating unit 108.

The image generating unit 108 generates an image (radar image) using the imaging method described above with the measurement signal selected by the signal selecting unit 107 as an input, and outputs the generated radar image.

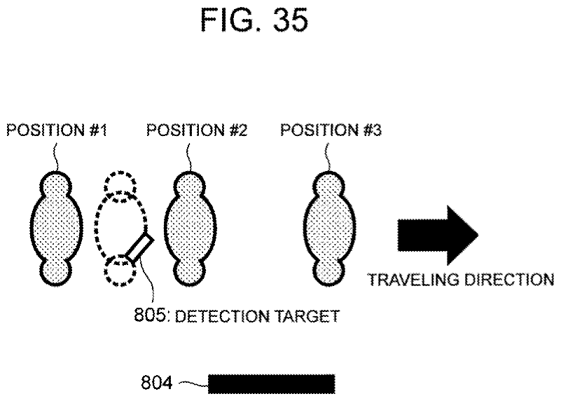

In this example embodiment, the radar system 100 selects measurement signals using a window (window size and degree of overlap) and generates a radar image from the selected measurement signals. Thus, it is possible to use overlapping signals between frames for imaging. As a result, the frame rate can be improved. In addition, the radar system 100 can image the detection target 805 (refer to FIG. 35) buried in the blur by limiting the measurement signals to be used by controlling the window and by changing the irradiation order.

### Example Embodiment 2

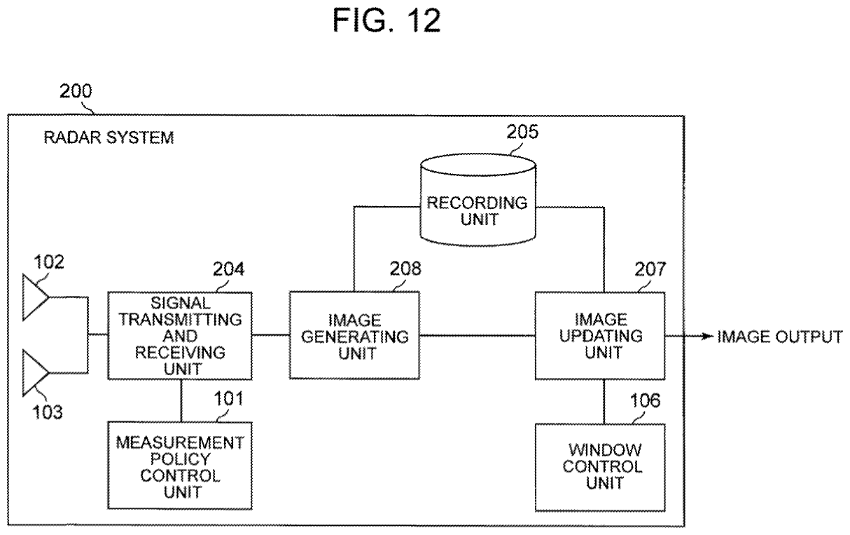

FIG. 12 is a block diagram showing an example configuration of a radar system of the second example embodiment. The radar system 200 of the second example embodiment includes a measurement policy control unit 101, a transmitting antenna 102, a receiving antenna 103, a signal transmitting and receiving unit 204 that instructs the transmitting antenna 102 and the receiving antenna 103 to transmit and receive electromagnetic waves based on the measurement policy, a radar image generating unit 208 that generates a radar image from the measurement signals, a recording unit 205 that stores the radar image, an image updating unit 207 that selects the radar image from the recording unit 205 and updates the radar image, and a window control unit 106 that determines a window for selecting measurement signals.

Although FIG. 12 illustrates a single transmitting antenna 102 and a single receiving antenna 103, the radar system 200 includes a plurality of transmitting antennas and a plurality of receiving antennas.

The measurement policy control unit 101, the transmitting antenna 102, the receiving antenna 103, and the window control unit 106 are configured in the same as those in the first example embodiment. The signal transmitting and receiving unit 204 operates in the same manner as the signal transmitting and receiving unit 104 in the first example embodiment, but in this example embodiment, the signal transmitting and receiving unit 204 does not store the measurement signal, the measurement time, and the group information in the recording unit. The signal transmitting and receiving unit 204 outputs the measurement signal, the irradiation time of the measurement signal (measurement time), and the group information of the transmitting antenna to the image generating unit 208.

The image generating unit 208 receives the measurement signal, the measurement time, and the group information of the transmitting antenna from the signal transmitting and receiving unit 204, and generates a radar image using an imaging method similar to the image generating unit 108 in the first example embodiment. The image generating unit 208 stores the radar image, the measurement time, and the group information of the transmitting antenna in the recording unit 205. Then, the image generating unit 208 notifies the image updating unit 207 that the radar image is stored in the recording unit 205.

The recording unit 205 stores the radar image and the measurement time for each group (by group number) based on the radar image and the measurement time from the image generating unit 208 and the group information of the transmitting antenna. The recording unit 205 also stores the updated radar image received from the image updating unit 207.

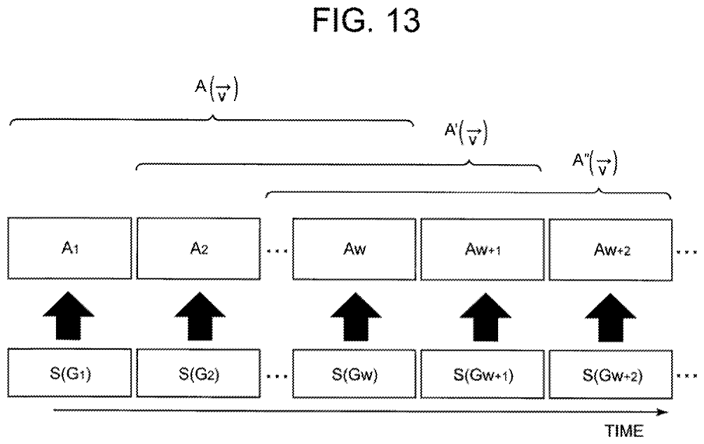

As shown in FIG. 13, the radar images generated from the measurement signals S(G1), S(G2), . . . , S(Gw), . . . , of group G1 are designated A1, A2, . . . , Aw, . . . , respectively. For the radar images for each group number, a new radar image is replaced with the oldest radar image, or all radar images are stored in the recording unit 205 together with the measurement time information as long as there is vacancy in the storage capacity of the recording unit 205. For the updated radar image received from the image updating unit 207, a new updated radar image is also replaced with the oldest updated radar image, or all the updated radar images are stored in the recording unit 205 as long as there is vacancy in the storage capacity of the recording unit 205.

When the image updating unit 207 receives a notification from the image generating unit 208 that a new radar image is stored in the recording unit 205, the image updating unit 207 selects a radar image from the recording unit 205 based on a window (window size and degree of overlap) from the window control unit 106. Then, the image updating unit 207 updates the final radar image with the selected radar image and makes it an updated radar image. The image updating unit 207 outputs the updated radar image to the recording unit 205 and also outputs it from the radar system 200.

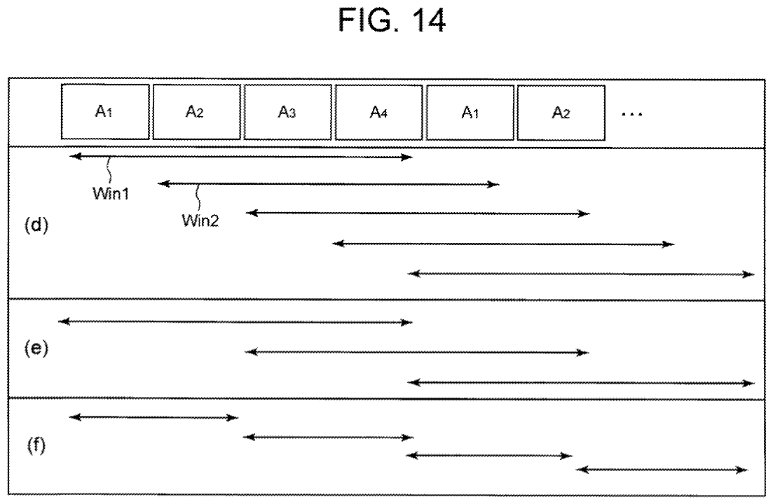

FIG. 14 is an explanatory diagram showing an example of a signal selection method based on a window size and a degree of overlap. The image selection method based on the window size W and the degree of overlap D is the same as the image selection method in the first example embodiment (refer to FIG. 8). However, the measurement signal (S(G1), etc.) in the first example embodiment is replaced by the radar image (A1, etc.) generated from the measurement signal in this example embodiment.

The radar image A (Vector(v)) that is finally obtained can be expressed by a sum of each voxel value. When the radar images selected by the image updating unit 207 are A1, A2, . . . , Aj, . . . , Aw, and when those radar images take the same area with the same number of pixels, the radar image A (Vector(v)) shown in equation (7) below using the window size W. The radar image may be treated as a complex number or as a real number.

[Math. 3]

A(\vec{v})=Σ^{W}ⱼ₌₁Aⱼ(\vec{v}) (7)

The updated radar image may be generated by a method different from the method using equation (7). For example, if the previously generated updated radar image A (Vector(v)) exists in the recording unit 205, the image updating unit 207 may obtain A (Vector(v)) and Aj (Vector(v)) from the recording unit 205 and generate a new updated radar image A′(Vector(v)) may be generated.

[Math. 4]

A′(\vec{v})=A(\vec{v})−Σ^{W-D}ⱼ₌₁Aⱼ(\vec{v})+Σ^{W+D}_{j=W+1}Aⱼ(\vec{v}) (8)

The generated A′ (Vector(v)) is stored in the recording unit 205 and is used to generate the next updated radar image A″ (Vector(v)).

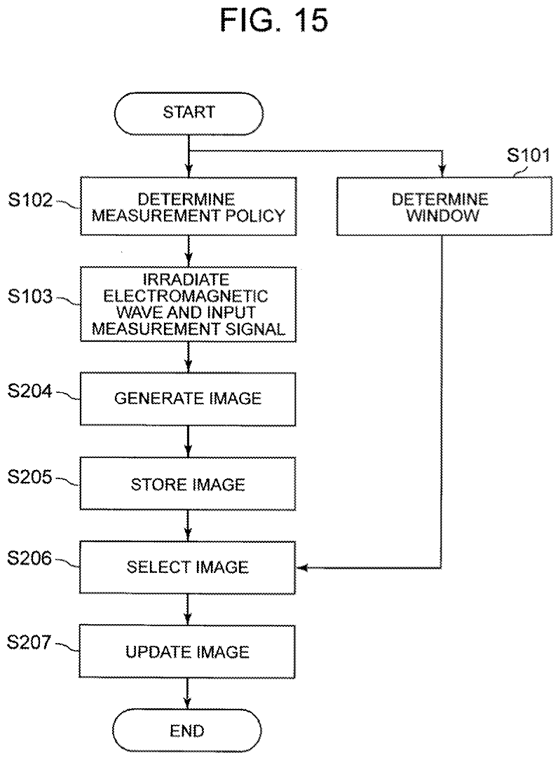

Next, with reference to the flowchart of FIG. 15, the operation of the radar system 200 will be described.

The processing of steps S101 to S103 is the same as the processing in the first example embodiment. However, in this example embodiment, the signal transmitting and receiving unit 204 outputs the measurement signal, the measurement time, and the group information to the image generating unit 208. Similar to the signal transmitting and receiving unit 104 in the first example embodiment, the signal transmitting and receiving unit 204 repeatedly executes the signal measurement process (the process of step S103).

The image generating unit 208 generates a radar image from the measurement signal input from the signal transmitting and receiving unit 204 using an imaging method (step S204). The image generating unit 208 can use the same imaging method used by the image generating unit 108 in the first example embodiment.

The image generating unit 208 stores the radar image and the measurement time for each group in the recording unit 205 (step S205). The image generating unit 208 notifies the image updating unit 207 that a new radar image has been stored in the recording unit 205.

When the image updating unit 207 receives a notification from the image generating unit 208, the image updating unit 207 selects an image from the recording unit 205 based on the window (window size and degree of overlap) input from the window control unit 106 (step S206).

The image updating unit 207 updates the radar image selected in the process of step S206 according to the above equation (7) or (8). The image updating unit 207 stores the updated radar image in the recording unit 205 (step S207) and outputs it from the radar system 200.

In this example embodiment, the radar system 200 selects measurement signals according to the window size and the degree of overlap, and generates an image using the selected measurement signals. Because of such a configuration, the frame rate can be improved. In addition, the radar system 200 can image a detection target buried in the blur by changing the irradiation order of the electromagnetic waves. In addition, the radar system 200 can reduce the amount of computation required for imaging processing because the radar system 200 stores imaging processing results for overlapping measurement signals and reuses the imaging processing results.

### Example Embodiment 3

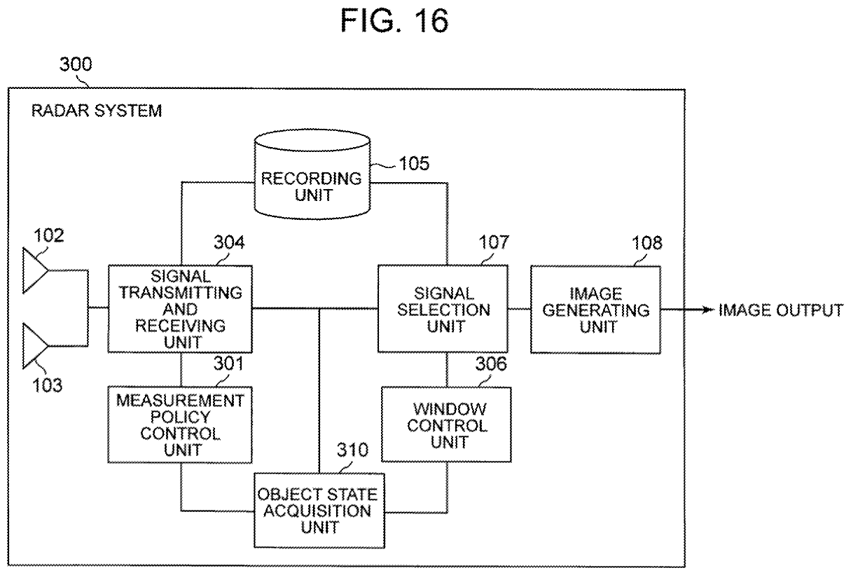

FIG. 16 is a block diagram showing an example configuration of a radar system of the third example embodiment. The radar system 300 of the third example embodiment includes a measurement policy control unit 301, a transmitting antenna 102, a receiving antenna 103, a signal transmitting and receiving unit 304 that instructs the transmitting antenna 102 and the receiving antenna 103 to transmit and receive electromagnetic waves based on the measurement policy, a recording unit 105 that stores measurement signals, a window control unit 306 that controls a window for selecting signals, a signal selection unit 107 that selects measurement signals from the recording unit 105, an image generating unit 108 that generates a radar image based on the measurement signals, and an object state acquisition unit 310 that acquires information of an object from the measurement signals.

Although FIG. 16 illustrates a single transmitting antenna 102 and a single receiving antenna 103, the radar system 300 includes a plurality of transmitting antennas and a plurality of receiving antennas. The signal selection unit 107 and the image generating unit 108 operate in the same manner as those in the first example embodiment.

The measurement policy control unit 301 determines a measurement policy (irradiation time interval at which the transmitting antennas irradiate electromagnetic waves, group information of the transmitting antennas, and irradiation order) based on information of the object 800 (refer to FIG. 32) output by the object state acquisition unit 310, and outputs the measurement policy to the signal transmitting and receiving unit 304. The information of the object 800 includes a position, a number, and speed of the object 800. The measurement policy control unit 301 determines an initial value of the measurement policy in the same way as the measurement policy control unit 101 determines the measurement policy in the first example embodiment.

The measurement policy control unit 301 may change the measurement policy. When changing the measurement policy, the measurement policy control unit 301 determines the measurement policy based on any one of the information (position, number, and speed) of the object 800 or a combination thereof, as follows.

The measurement policy control unit 301 determines the irradiation time interval I of the electromagnetic wave from the transmitting antenna 102 using the following equations (9) to (11) based on any one or a combination of the information (position, number, and speed) of the object 800. The measurement policy control unit 301 increases the irradiation time interval I the farther the position of the object 800 is from the antenna position. As the antenna position, for example, the center of gravity or the median of the plurality of transmitting antennas 102 and the plurality of receiving antennas 103 is used. As the position of the object 800, for example, the point where the reflection intensity is strongest or the center of gravity calculated from the reflection intensity and the position of the object 800 is used. When a distance between the position of the object 800 and the antenna position is B, the measurement policy control unit 301 calculates the irradiation time interval I using the equation (9), for example.

I=α*B (α is a coefficient) (9)

The measurement policy control unit 301 lengthens the irradiation time interval I as the number of the objects 800 increases. In that case, when the number of objects (the number of voxels having a large reflection intensity) is C, the measurement policy control unit 301 calculates the irradiation time interval I using the equation (10), for example.

I=α*C (α is a coefficient) (10)

The greater the speed of the object 800, the measurement policy control unit 301 shortens the irradiation time interval I. In that case, the measurement policy control unit 301 calculates the irradiation time interval I as follows, when the speed of the object is E.

I=α/E (α is a coefficient) (11)

The measurement policy control unit 301 handles the group information of the transmitting antennas in the same way as in the first example embodiment.

The measurement policy control unit 301 determines the irradiation order based on any one of the information (position, number, speed) of the object 800 or a combination thereof as follows.

The measurement policy control unit 301 determines, for example, the order of irradiation in the measurement policy so that irradiation of electromagnetic waves is started from the transmitting antenna 102 that is physically close to the position of the object 800. Alternatively, the measurement policy control unit 301 determines the irradiation order based on the direction of movement of the object 800, so that the electromagnetic waves are irradiated in order from the transmitting antenna 102 which enlarges an incidence angle from the radar toward movement direction (vector).

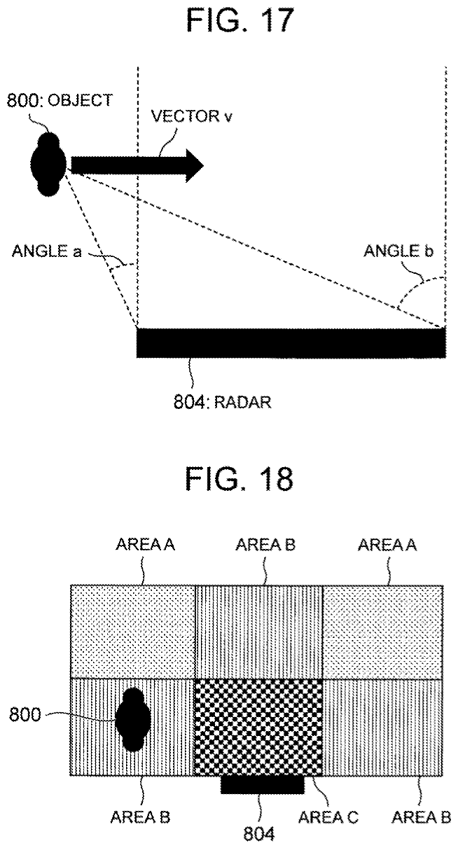

FIG. 17 is an explanatory diagram for explaining an irradiation order based on a position of an object 800. As shown in FIG. 17, when the movement direction of the object 800 is represented by the vector v, since the angle of the incidence angle (angle b) from the transmitting antenna 102 located on the right side in the radar 804 is larger than the incidence angle (angle a) from the transmitting antenna 102 located on the left side in the radar 804, the measurement policy control unit 301 determines the irradiation order so that the electromagnetic waves are irradiated in order from the transmitting antenna 102 located on the right side.

The signal transmitting and receiving unit 304 performs the same processing as the signal transmitting and receiving unit 104 in the first example embodiment. However, the signal transmitting and receiving unit 304 also performs a process of outputting a measurement signal to the object state acquisition unit 310 in addition to the process performed by the signal transmitting and receiving unit 104.

The window control unit 306 inputs information of the object 800 from the object state acquisition unit 310. The window control unit 306 determines the window size and the degree of overlap based on the information of the object 800, and outputs them to the signal selection unit 107. The window control unit 306 determines an initial value of the window (window size and degree of overlap) in the same way as the window control unit 106 determines the window in the first example embodiment. When changing the window, the window control unit 306 determines the window size and the degree of overlap based on any one of the information (position, number, and speed) of the object 800 or a combination thereof, using the following equations (12) to (17).

The window control unit 306 increases the window size W the farther the position of the object 800 is from the radar position. For example, the window control unit 306 calculate the distance as follows, when the distance from the radar position to the position of the object is F.

W=α*F (α is a coefficient) (12)

FIG. 18 is an explanatory diagram for explaining an irradiation order based on a position of an object. The window control unit 306 divides the area 802 (refer to FIG. 32) into a plurality of imaging areas in advance, as shown in FIG. 18. The window control unit 306 may determine a window size W for each area in which the object 800 is located. For example, the window control unit 306 determines the window size W for each area, such as W=2 for area A, W=3 for area B, and W=4 for area C.

The window control unit 306 makes the window size W smaller as the number of the objects 800 increases. For example, the window control unit 306 calculates the window size W using the following equation (13), when the number of objects is G.

W=α/G (α is a coefficient) (13)

The window control unit 306 makes the window size W smaller as the speed of the object 800 is larger. For example, the window size W is calculated using the following equation (14), when the speed of the object 800 is V.

W=α/V (α is a coefficient) (14)

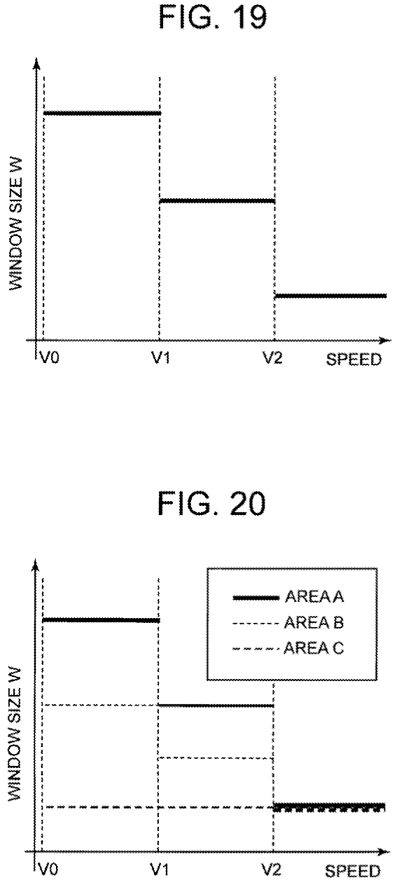

FIG. 19 is an explanatory diagram for explaining a window size selection method based on the speed of the object 800. The window control unit 306 generates a relationship between the speed and the window size in advance, as shown in FIG. 19. Then, the window control unit 306 determines the window size W according to the calculated speed of the object 800, for example.

FIG. 20 is an explanatory diagram for explaining a window size selection method based on the position and the speed of the object. The window control unit 306 may determine the window size W for each area and the speed as shown in FIG. 20 by combining the position and the speed of the object 800. The window control unit 306 increases the degree of overlap D the closer the position of the object 800 is to the radar position. For example, the window control unit 306 calculates the degree of overlap D using the following equation (15), when the distance from the radar position to the position of the object is F.

D=α/F (α is a coefficient) (15)

The window control unit 306 reduces the degree of overlap D as the number of objects 800 increases. For example, the window control unit 306 calculates the degree of overlap D using the following equation (16), when the number of objects is G.

D=α/G (α is a coefficient) (16)

The window control unit 306 increases the degree of overlap D as the speed of the object is larger. For example, the window control unit 306 calculates the degree of overlap D using the following equation (17), wherein the speed of the object is V.

D=α/V (α is a coefficient) (17)

The object state acquisition unit 310 inputs a measurement signal from the signal transmitting and receiving unit 304. The object state acquisition unit 310 outputs information (position, number, and speed) of the object 800 to the measurement policy control unit 301 and the window control unit 306.

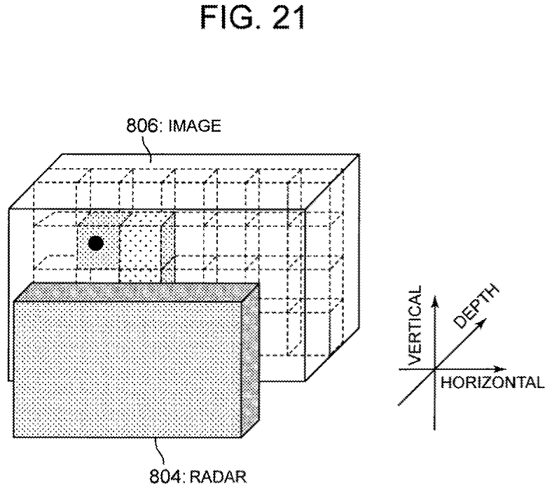

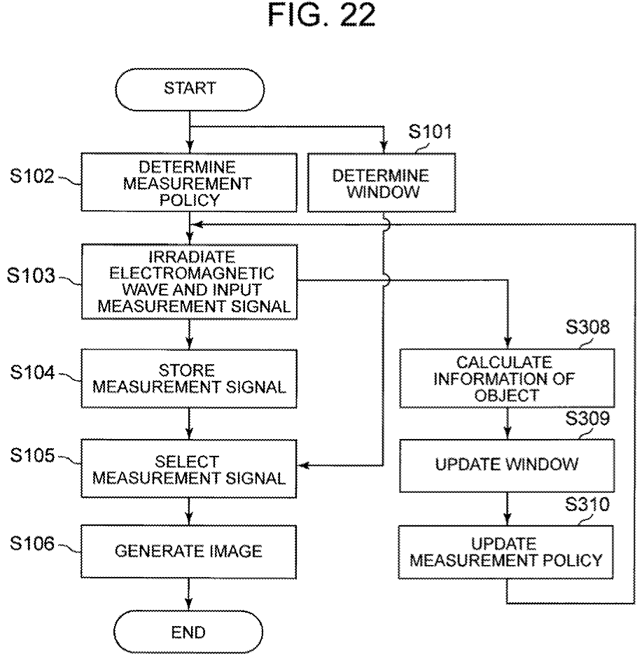

The object state acquisition unit 310 calculates the position of the object 800 using, for example, a method similar to the imaging method used by the image generating unit 308. FIG. 21 is an explanatory diagram showing a coordinate system of the radar and the image. The object state acquisition unit 310 may calculate the position of the object 800 from a two-dimensional image made by adding values in the vertical direction (or projected in the vertical direction) of a three-dimensional radar image (image 806) having horizontal, vertical, and depth coordinates illustrated in FIG. 21. In such a case, the object state acquisition unit 310 uses, for example, the median of them or the center of gravity based on the reflection intensity, when there are a plurality of pixels with large intensity in the two-dimensional radar image and they are adjacent to each other. When the pixels with large intensity are not adjacent to each other, the object state acquisition unit 310 can use their positions.

As the number of objects 800, the object state acquisition unit 310 may use, as in the case of the position of the objects, the number of pixels whose reflection intensity exceeds a predetermined threshold value in a two-dimensional image made by adding values in the vertical direction (or projected in the vertical direction) of a three-dimensional radar image (image 806) illustrated in FIG. 21. When a plurality of pixels whose reflection intensity exceeds the predetermined threshold are adjacent to each other, the object state acquisition unit 310 considers the plurality of pixels to be one object. In the case where the plurality of pixels whose reflection intensity exceeds the predetermined threshold are not adjacent to each other, the object state acquisition unit 310 considers the number of those pixels to be the number of objects.

When detecting the speed of the object 800, the object state acquisition unit 310 generates a two-dimensional image from the measurement signal by adding values in the vertical direction (or projected in the vertical direction) of a three-dimensional radar image (image 806) illustrated in FIG. 21. Then, the object state acquisition unit 310 estimates the amount of movement from the two successive images using, for example, an optical flow-based method described in non-patent literature 2. The object state acquisition unit 310 can calculate a velocity by dividing the amount of movement by a time (movement time).

The information of the object may be directly input by the user through a GUI or the like.

Next, with reference to the flowchart of FIG. 22, the operation of the radar system 300 will be described.

The processing of steps S101 to S106 is the same as the processing in the first example embodiment. However, in this example embodiment, the window size and the degree of overlap determined by using, for example, above equations (3) and (4) are treated as initial values in the processing of step S101. In addition, the signal transmitting and receiving unit 304 outputs the measurement signal, the measurement time, and the group information calculated in the processing of step S103 to the object state acquisition unit 310. Similar to the signal transmitting and receiving unit 104 in the first example embodiment and the signal transmitting and receiving unit 204 in the second example embodiment, the signal transmitting and receiving unit 304 repeatedly executes the signal measurement process (the process of step S103).

The object state acquisition unit 310 calculates information of the object (position, number, and speed of the object) using the measurement signals input from the signal transmitting and receiving unit 304, as described above (step S308). Then, the object state acquisition unit 310 outputs the information of the object to the measurement policy control unit 301 and the window control unit 306.

The window control unit 306 inputs information of the object (position, number, and speed of the object) from the object state acquisition unit 310, and determines the window size and the degree of overlap based on the information of the object (step S309). That is, the window control unit 306 updates the window (window size and degree of overlap). The window control unit 306 outputs the updated window size and the updated degree of overlap to the signal selection unit 107.

The measurement policy control unit 301 inputs information of the object (position, number, and speed of the object) from the object state acquisition unit 310, and determines a measurement policy (irradiation time interval at which the transmitting antenna irradiates electromagnetic waves, group information of the transmitting antenna, and irradiation order) based on the information of the object (step S310). That is, the measurement policy control unit 301 updates the measurement policy. The measurement policy control unit 301 outputs the updated measurement policy to the signal transmitting and receiving unit 304.

When the signal transmitting and receiving unit 304 receives the updated measurement policy from the signal transmitting and receiving unit 304, the signal transmitting and receiving unit 304 executes the process of step S103 according to the updated measurement policy.

In this example embodiment, since the radar system 300 selects a measurement signal based on a window (window size and degree of overlap) determined (updated) based on information (position, number, and speed) of the object, the frame rate can be further improved compared to the first example embodiment. In addition, since the radar system 300 changes the measurement policy (irradiation order and irradiation time interval) based on the information (position, number, and velocity) of the object, the radar system 300 can more accurately image the detected object buried in the blur.

### Example Embodiment 4

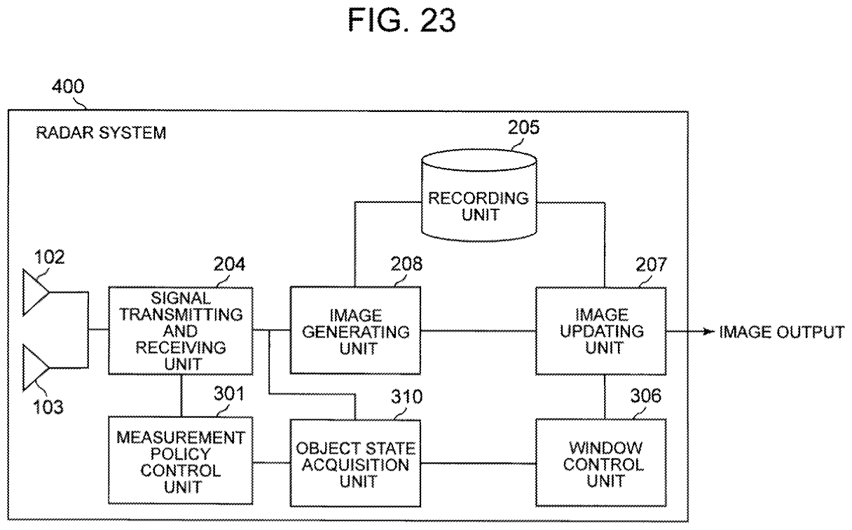

FIG. 23 is a block diagram showing an example configuration of a radar system of the fourth example embodiment. The radar system 400 of the fourth example embodiment includes a measurement policy control unit 301, a transmitting antenna 102, a receiving antenna 103, a signal transmitting and receiving unit 204 that instructs the transmitting antenna 102 and the receiving antenna 103 to transmit and receive electromagnetic waves based on the measurement policy, a recording unit 205 that stores a radar image, an image updating unit 207 that selects a radar image from the recording unit 205 and updates the radar image, an object state acquisition unit 310 that acquires information of an object from the measurement signal, and a window control unit 306 that determines a window for selecting the measurement signals.

Although FIG. 23 illustrates a single transmitting antenna 102 and a single receiving antenna 103, the radar system 400 includes a plurality of transmitting antennas and a plurality of receiving antennas.

This example embodiment corresponds to an example embodiment which is a combination of the second example embodiment and the third example embodiment. That is, the signal transmitting and receiving unit 204 and the image updating unit 207 operate in the same manner as those in the second example embodiment. The measurement policy control unit 301 and the object state acquisition unit 310 operate in the same manner as those in the third example embodiment.

The window control unit 306 operates in the same manner as the window control unit 306 in the third example embodiment. However, in this example embodiment, the window determined by the window control unit 306 is supplied to the image updating unit 207.

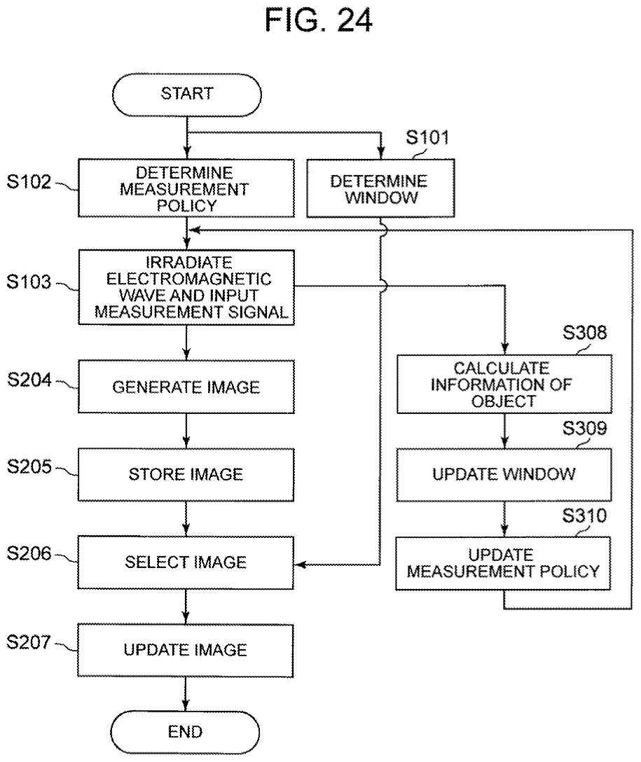

Next, with reference to the flowchart of FIG. 24, the operation of the radar system 400 will be described.

The processing of steps S101 to S103 is the same as the processing in the first example embodiment to the third example embodiment. However, as in the case of the third example embodiment, an initial values of the window size and the degree of overlap are determined in the processing of step S101 using, for example, the above equations (3) and (4).

As in the case of the second example embodiment, the signal transmitting and receiving unit 204 outputs the measurement signal calculated in the processing of step S103, the irradiation time of the measurement signal (measurement time), and the group information of the transmitting antenna to the image generating unit 208. In addition, the signal transmitting and receiving unit 204 outputs the measurement signal calculated in the processing of step S103, the measurement time, and the group information to the object state acquisition unit 310 in the same manner as in the case of the third example embodiment. As in the case of the first to third example embodiments, the signal transmitting and receiving unit 204 repeatedly executes the signal measurement process (the process of step S103).

The processing of steps S204 to S207 is the same as the processing in the second example embodiment shown in FIG. 15. The processing of steps S308 to S310 is the same as the processing in the third example embodiment shown in FIG. 22.

Since this example embodiment corresponds to an example embodiment in which the second example embodiment and the third example embodiment are combined, the radar system 400 obtains both the effects of the second example embodiment and the effects of the third example embodiment. That is, since the radar system 400 selects signals according to the window size and the degree of overlap determined (updated) based on the information (position, number, and speed) of the object, and generates an image with the selected signals, the frame rate can be further improved. In addition, since the radar system 400 changes the irradiation order based on the information of the object (position, number, and speed), the detected object buried in the blur can be imaged more accurately. Further, the radar system 400 can reduce the amount of computation required to perform imaging processing on overlapping measurement signals.

### Example Embodiment 5

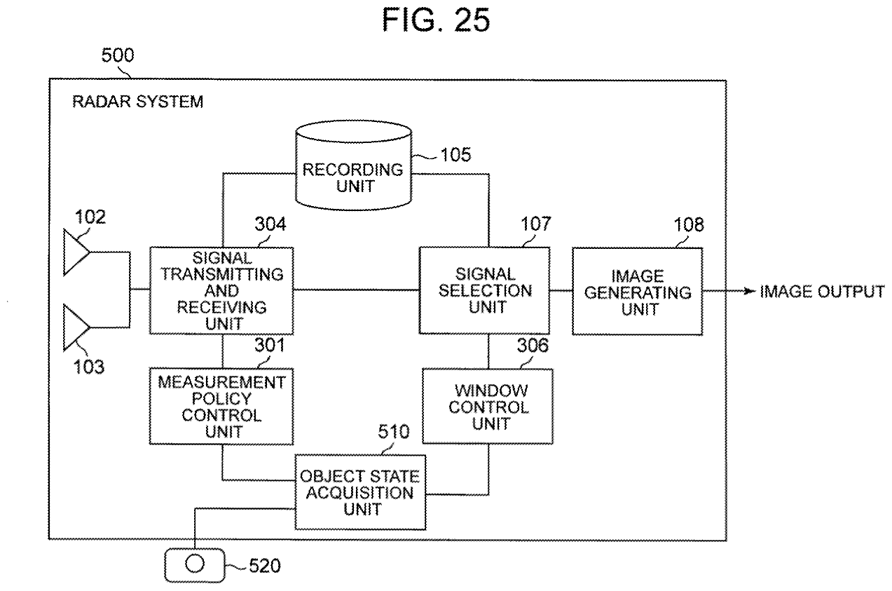

FIG. 25 is a block diagram showing an example configuration of a radar system of the fifth example embodiment. The radar system 500 of the fifth example embodiment includes a measurement policy control unit 301, a transmitting antenna 102, a receiving antenna 103, a signal transmitting and receiving unit 304 that instructs the transmitting antenna 102 and the receiving antenna 103 to transmit and receive electromagnetic waves based on the measurement policy, a recording unit 105 that stores measurement signals, a window control unit 306 that controls a window for selecting the measurement signals, a signal selection unit 107 that selects the measurement signals from the recording unit 105, an image generating unit 108 that generates a radar image based on the measurement signals, and an object state acquisition unit 510 that acquires information of the object 800 from an external sensor 520.

Although FIG. 25 illustrates a single transmitting antenna 102 and a single receiving antenna 103, the radar system 500 includes a plurality of transmitting antennas and a plurality of receiving antennas.

The radar system 500 of this example embodiment has a configuration in which an object state acquisition unit 510 is provided instead of the object state acquisition unit 310 in the third example embodiment.

The object state acquisition unit 510 calculates information (position, number, and speed) of the object 800 based on sensing information from an external sensor. The object state acquisition unit 510 outputs the calculated information of the object 800 to the measurement policy control unit 301 and the window control unit 306.

The external sensor 520 is installed at a position (for example, a position where the area 802 shown in FIG. 32 can be photographed) where the external sensor 520 can grasp the object 800. As the external sensor 520, a visible light camera (monocular camera, ToF (Time of Flight) camera, stereo camera, etc.), an infrared camera, a LIDAR (Light Detection and Ranging) device, or the like can be used.

The object state acquisition unit 510 can use three-dimensional data obtained from the external sensor 520 to calculate information (position, number, and speed) of the object 800 using, for example, an optical flow-based method as described in non-patent literature 2. The object state acquisition unit 510 can also calculate the information of the object 800 using the ICP method as described in non-patent literature 3.

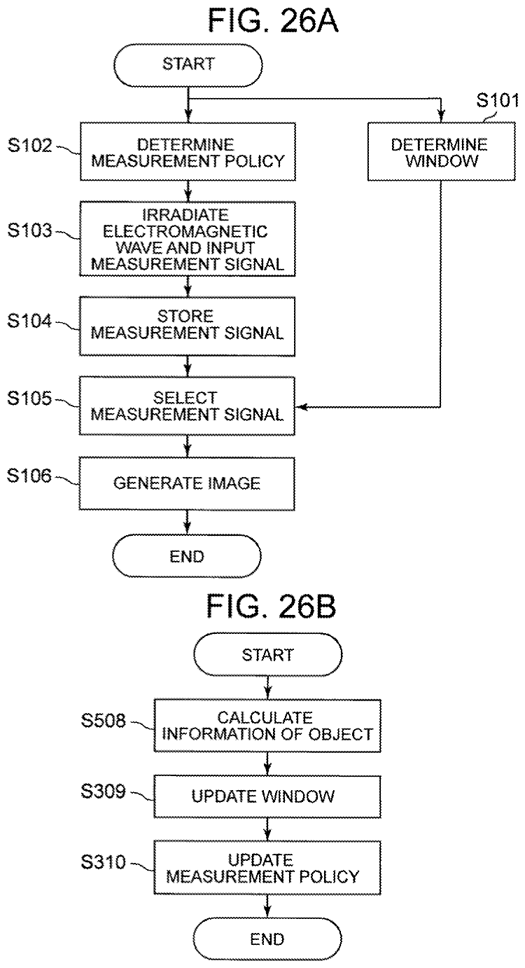

Next, with reference to the flowcharts of FIG. 26A and FIG. 26B, the operation of the radar system 500 will be described.

The processing shown in FIG. 26A is the same as the processing of steps S101 to S106 in the third example embodiment shown in FIG. 22. However, in this example embodiment, the signal transmitting and receiving unit 304 does not output the measurement signal or the like to the object state acquisition unit 510.

FIG. 26B shows operations of the object state acquisition unit 510 and the window control unit 306 in this example embodiment. The object state acquisition unit 510 calculates information (position, number, and speed) of the object 800 based on sensing information of the external sensor 520 (step S508). The object state acquisition unit 510 outputs the calculated information of the object 800 to the measurement policy control unit 301 and the window control unit 306.

Similarly to the case of the third example embodiment (refer to FIG. 22), the window control unit 306 inputs information of the object (position, number, and speed of the object) from the object state acquisition unit 510, and updates the window size and the degree of overlap based on the information of the object (step S309).

Similar to the case of the third example embodiment (refer to FIG. 22), the measurement policy control unit 301 inputs information of the object (position, number, and speed of the object) from the object status acquisition unit 510, and updates the measurement policy (irradiation time interval at which the transmitting antenna irradiates electromagnetic waves, group information of the transmitting antenna, and irradiation order) based on the information of the object (step S310).

The radar system 500 of this example embodiment has the same effect as that of the third example embodiment. In this example embodiment, the information of the object 800 is calculated based on the sensing information of the external sensor 520, but the third example embodiment may be combined to this example embodiment. That is, the radar system 500 may calculate the information of the object 800 based on either the sensing information of the external sensor 520 or the analysis result of the measurement signal.

### Example Embodiment 6

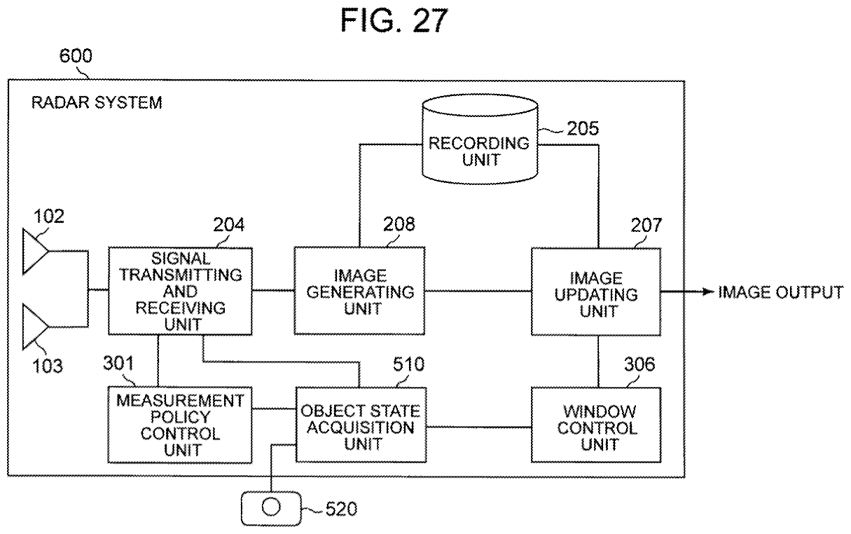

FIG. 27 is a block diagram showing an example configuration of a radar system of the sixth example embodiment. The radar system 600 of the sixth example embodiment includes a measurement policy control unit 301, a transmitting antenna 102, a receiving antenna 103, a signal transmitting and receiving unit 204 that instructs the transmitting antenna 102 and the receiving antenna 103 to transmit and receive electromagnetic waves based on the measurement policy, an image generating unit 208 that generates a radar image from the measurement signal, a recording unit 205 for storing the radar image, an image updating unit 207 for selecting the radar image from the recording unit 205 and updating the radar image, an object state acquisition unit 510 for acquiring information of the object 800 from an external sensor 520, and a window control unit 306 for determining a window for selecting measurement signals.

Although FIG. 27 illustrates a single transmitting antenna 102 and a single receiving antenna 103, the radar system 600 includes a plurality of transmitting antennas and a plurality of receiving antennas.

The radar system 600 of this example embodiment has a configuration in which an object state acquisition unit 510 is provided instead of the object state acquisition unit 310 in the fourth example embodiment.

As in the fifth example embodiment, the external sensor 520 is installed at a position (for example, a position where the area 802 shown in FIG. 32 can be photographed) where the external sensor 520 can grasp the object 800. As the external sensor 520, a visible light camera (monocular camera, ToF (Time of Flight) camera, stereo camera, etc.), an infrared camera, a LIDAR (Light Detection and Ranging) device, or the like can be used.

As in the fifth example embodiment, the object state acquisition unit 510 can use three-dimensional data obtained from the external sensor 520 to calculate information (position, number, and speed) of the object 800 using, for example, an optical flow-based method as described in non-patent literature 2. The object state acquisition unit 510 can also calculate the information of the object 800 using the ICP method as described in non-patent literature 3.

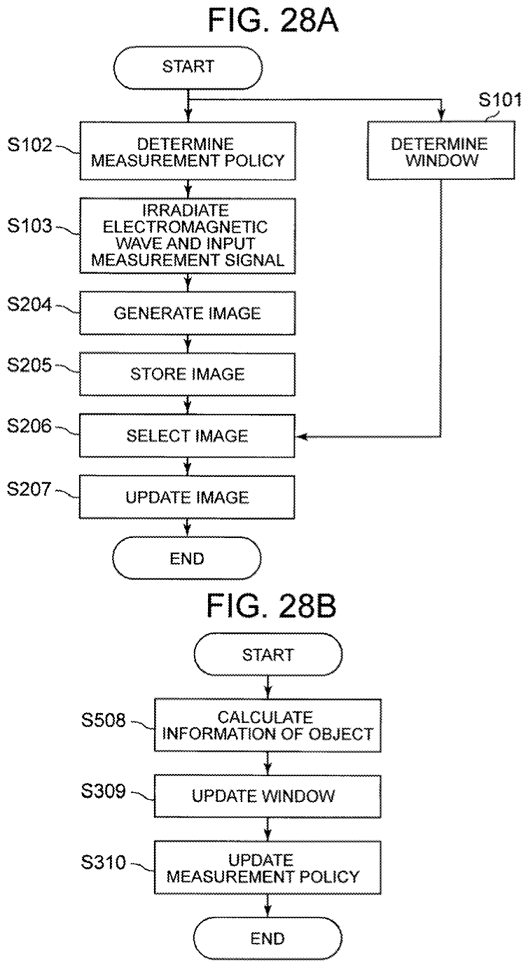

Next, the operation of the radar system 600 will be described with reference to the flowcharts of FIG. 28A and FIG. 28B.

The processing shown in FIG. 28A is the same as the processing of steps S101 to S103 and S204 to S207 in the fourth example embodiment shown in FIG. 24. However, in this example embodiment, the signal transmitting and receiving unit 204 does not output the measurement signal or the like to the object state acquisition unit 510.

FIG. 28B shows operations of the object state acquisition unit 510 and the window control unit 306 in this example embodiment. The object state acquisition unit 510 calculates information (position, number, and speed) of the object 800 based on sensing information of the external sensor 520 (step S508). The object state acquisition unit 510 outputs the calculated information of the object 800 to the measurement policy control unit 301 and the window control unit 306.

Similarly to the case of the fourth example embodiment (refer to FIG. 24), the window control unit 306 inputs information of the object (position, number, and speed of the object) from the object state acquisition unit 510, and updates the window size and the degree of overlap based on the information of the object (step S309).

Similar to the case of the fourth example embodiment (refer to FIG. 24), the measurement policy control unit 301 inputs information of the object (position, number, and speed of the object) from the object status acquisition unit 510, and updates the measurement policy (irradiation time interval at which the transmitting antenna irradiates electromagnetic waves, group information of the transmitting antenna, and irradiation order) based on the information of the object (step S310).

The radar system 600 of this example embodiment has the same effect as that of the fourth example embodiment. In this example embodiment, the information of the object 800 is calculated based on the sensing information of the external sensor 520, but the fourth example embodiment may be combined to this example embodiment. That is, the radar system 500 may calculate the information of the object 800 based on either the sensing information of the external sensor 520 or the analysis result of the measurement signal.

The functions (processes) in the above example embodiments may be realized by a computer having a processor such as a central processing unit (CPU), a memory, etc. For example, a program for performing the method (processing) in the above example embodiments may be stored in a storage device (storage medium), and the functions may be realized with the CPU executing the program stored in the storage device.

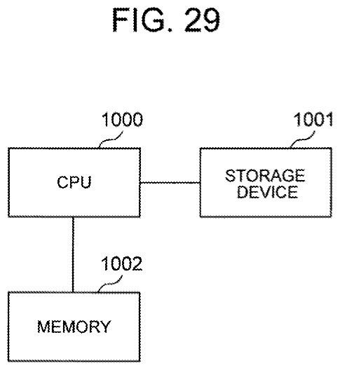

FIG. 29 is a block diagram showing an example of a computer with a CPU. The computer is implemented in a radar system. The CPU 1000 executes processing in accordance with a program stored in a storage device 1001 to realize the functions in the above example embodiments. That is to say, the functions of the measurement policy control units 101, 301, the signal transmitting and receiving units 104, 204, 304, the window control units 106, 306, the signal selection unit 107, the image generating units 108, 208 (software portion of the image generating units 108, 208 if the image generating units 108, 208 includes a hardware portion), the image updating unit 207, and the object state acquisition units 310, 510 in the radar systems 100, 200, 300, 400, 500, 600 shown in FIGS. 1, 12, 16, 23, 25, and 27.

A GPU (Graphics Processing Unit) may be used instead of the CPU 1000 or together with the CPU 1000.

A storage device 1001 is, for example, a non-transitory computer readable media. The non-transitory computer readable medium is one of various types of tangible storage media. Specific examples of the non-transitory computer readable media include a magnetic storage medium (for example, flexible disk, magnetic tape, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

The memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

The memory 1002 or the storage device 100 realizes the recording units 105, 205 in each of the above example embodiments.

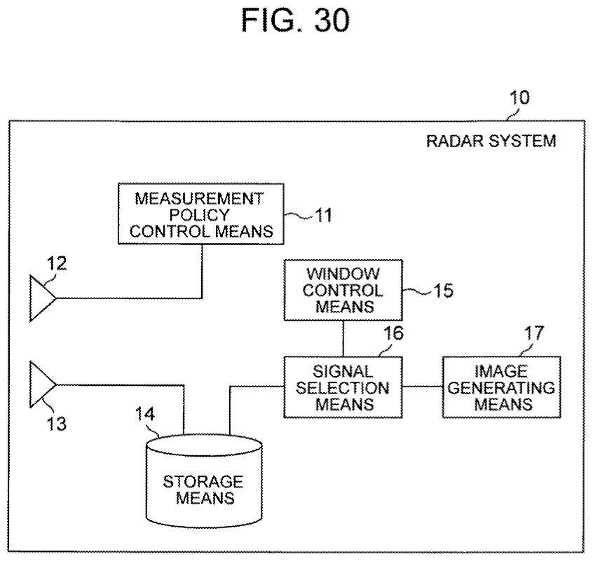

FIG. 30 is a block diagram showing a main part of a radar system. The radar system 10 shown in FIG. 30 comprises measurement policy control means 11 (in an example embodiments, realized by the measurement policy control unit 101) for determining a measurement policy relating to how a signal is to be measured, a transmitting antenna 12 (in an example embodiments, realized by the transmitting antenna 102) that irradiates electromagnetic waves according to the measurement policy, a receiving antenna 13 (in an example embodiments, realized by the receiving antenna 103) that receives reflected waves of the irradiated electromagnetic waves and generates a measurement signal, storage means 14 (in the example embodiments, realized by the recording unit 105) for storing the measurement signals, window control means 15 (in an example embodiments, realized by the window control unit 106) for determining a window for selecting the measurement signals, signal selection means 16 (in the example embodiments, realized by the signal selecting unit 107) for selecting measurement signals from the storage means 14 based on the window, and image generating means 17 (in the example embodiments, realized by the image generating unit 108) for generating a radar image from the selected measurement signals.

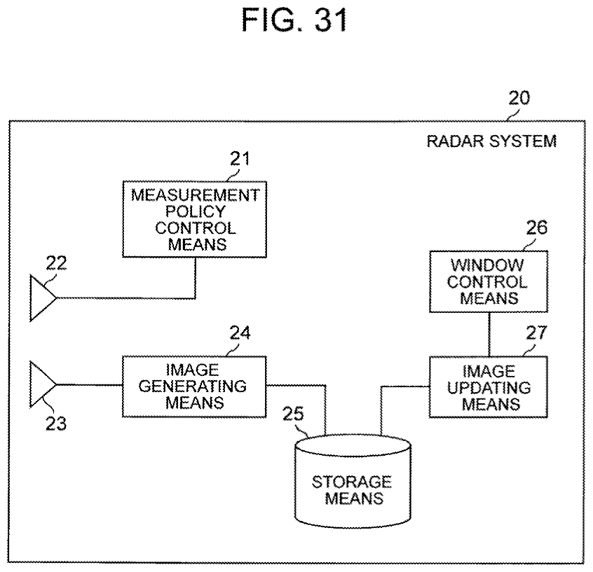

FIG. 31 is a block diagram of a main part of another aspect of a radar system. The radar system 20 shown in FIG. 31 comprises measurement policy control means 21 (in an example embodiments, realized by the measurement policy control unit 101) for determining a measurement policy relating to how a signal is to be measured, a transmitting antenna 22 (in an example embodiments, realized by the transmitting antenna 102) that irradiates electromagnetic waves according to the measurement policy, a receiving antenna 23 (in an example embodiments, realized by the receiving antenna 103) that receives reflected waves of the irradiated electromagnetic waves and generates a measurement signal, image generating means 24 (in the example embodiments, realized by the image generating unit 208) for generating a radar image from the measurement signals, storage means 25 (in the example embodiments, realized by the recording unit 205) for storing the radar images, window control means 26 (in the example embodiments, realized by the window control unit 106) for determining a window for selecting the radar image, and image updating means 27 (in the example embodiments, realized in the image updating unit 207) for selecting the radar image from the storage means based on the window and generating an updated radar image based on the selected radar image.

A part of or all of the above example embodiments may also be described as, but not limited to, the following supplementary notes.

(Supplementary note 1) A radar system comprising:

measurement policy control means for determining a measurement policy relating to how a signal is to be measured,

a transmitting antenna that irradiates electromagnetic waves according to the measurement policy,

a receiving antenna that receives reflected waves of the irradiated electromagnetic waves and generates a measurement signal,

storage means for storing the measurement signals,

window control means for determining a window for selecting the measurement signals,

signal selection means for selecting measurement signals from the storage means based on the window, and

image generating means for generating a radar image from the selected measurement signals.

(Supplementary note 2) The radar system according to Supplementary note 1, further comprising

grouping means for grouping a plurality of transmitting antennas, wherein

the storage means stores the measurement signals for each group.

(Supplementary note 3) A radar system comprising:

measurement policy control means for determining a measurement policy relating to how a signal is to be measured,

a transmitting antenna that irradiates electromagnetic waves according to the measurement policy,

a receiving antenna that receives reflected waves of the irradiated electromagnetic waves and generates a measurement signal,

image generating means for generating a radar image from the measurement signals,

storage means for storing the radar images,

window control means for determining a window for selecting the radar image, and

image updating means for selecting the radar image from the storage means based on the window and generating an updated radar image based on the selected radar image.

(Supplementary note 4) The radar system according to Supplementary note 3, wherein

the image updating means stores the updated radar image in the storage means.

(Supplementary note 5) The radar system according to Supplementary note 4, wherein

the image updating means generates a new updated radar image from the selected radar image and the updated radar image stored in the storage means.

(Supplementary note 6) The radar system according to any one of Supplementary notes 3 to 5, further comprising

grouping means for grouping a plurality of transmitting antennas, wherein

the storage means stores the radar images for each group.

(Supplementary note 7) The radar system according to any one of Supplementary notes 1 to 6, wherein

the window control means determines a window size and degree of overlap for determining the number of the measurement signals or the radar images and selection timing for selecting the measurement signals or the radar images, as the window.

(Supplementary note 8) The radar system according to any one of Supplementary notes 1 to 7, wherein

the measurement policy control means determines an irradiation time interval of the electromagnetic wave, group information regarding the transmitting antenna, and an irradiation order, as the measurement policy.

(Supplementary note 9) An imaging method comprising:

determining a measurement policy relating to how a signal is to be measured,

irradiating electromagnetic waves from a transmitting antenna according to the measurement policy,

receiving reflected waves of the irradiated electromagnetic waves by a receiving antenna and generating a measurement signal,

storing the measurement signal in storage means,

determining a window for selecting the measurement signals,

selecting measurement signals from the storage means based on the window, and

generating a radar image from the selected measurement signals.

(Supplementary note 10) An imaging method comprising:

determining a measurement policy relating to how a signal is to be measured,

irradiating electromagnetic waves from a transmitting antenna according to the measurement policy,

receiving reflected waves of the irradiated electromagnetic waves by a receiving antenna and generating a measurement signal,

generating a radar image from the measurement signals,

storing the radar image in storage means,

determining a window for selecting the radar image, and

selecting the radar image from the storage means based on the window and generating an updated radar image based on the selected radar image.

(Supplementary note 11) The imaging method according to Supplementary note 10, further comprising

storing the updated radar image in the storage means.

(Supplementary note 12) The imaging method according to Supplementary note 11, further comprising

generating a new updated radar image from the selected radar image and the updated radar image stored in the storage means.

(Supplementary note 13) The imaging method according to any one of Supplementary notes 9 to 12, further comprising

determining a window size and degree of overlap for determining the number of the measurement signals or the radar images and selection timing for selecting the measurement signals or the radar images, as the window.

(Supplementary note 14) The imaging method according to any one of Supplementary notes 9 to 13, further comprising

determining an irradiation time interval of the electromagnetic wave, group information regarding the transmitting antenna, and an irradiation order, as the measurement policy.

(Supplementary note 15) An imaging program causing a computer to execute:

a process of determining a measurement policy relating to how a signal is to be measured,

a process of generating a measurement signal based on reflected waves of irradiated electromagnetic waves irradiated according to the measurement policy,

a process of storing the measurement signal in storage means,

a process of determining a window for selecting the measurement signals,

a process of selecting measurement signals from the storage means based on the window, and

a process of generating a radar image from the selected measurement signals.

(Supplementary note 16) An imaging program causing a computer to execute:

a process of determining a measurement policy relating to how a signal is to be measured,

a process of generating a measurement signal based on reflected waves of irradiated electromagnetic waves irradiated according to the measurement policy,

a process of generating a radar image from the measurement signals,

a process of storing the radar image in storage means,

a process of determining a window for selecting the radar image, and

a process of selecting the radar image from the storage means based on the window and generating an updated radar image based on the selected radar image.

(Supplementary note 17) The imaging program according to Supplementary note 16, further causing the computer to execute

a process of storing the updated radar image in the storage means.

(Supplementary note 18) The imaging program according to Supplementary note 17, further causing the computer to execute

a process of generating a new updated radar image from the selected radar image and the updated radar image stored in the storage means.

(Supplementary note 19) The imaging program according to any one of Supplementary notes 15 to 18, further causing the computer to execute

a process of determining a window size and degree of overlap for determining the number of the measurement signals or the radar images and selection timing for selecting the measurement signals or the radar images, as the window.

(Supplementary note 20) The imaging program according to any one of Supplementary notes 15 to 19, further causing the computer to execute

a process of determining an irradiation time interval of the electromagnetic wave, group information regarding the transmitting antenna, and an irradiation order, as the measurement policy.

(Supplementary note 21) The radar system according to Supplementary note 6, wherein

the grouping means groups the plurality of transmitting antennas based on the position of the transmitting antennas.

(Supplementary note 22) The radar system according to Supplementary note 6, wherein

the grouping means groups the plurality of transmitting antennas so that antennas close to each other are included in one group.

(Supplementary note 23) The radar system according to any one of Supplementary notes 1 to 8, 21 and 22, further comprising object state acquisition means to acquire information of the object.

(Supplementary note 24) The radar system according to Supplementary note 23, wherein

the object information includes a location, a number, or speed of the object.

(Supplementary note 25) The radar system according to Supplementary note 22 or 23, wherein

the window control means determines the window based on the information of the object.

(Supplementary note 26) The radar system according to Supplementary note 25, wherein

the window control means reduces the window size when speed of the object is large.

(Supplementary note 27) The radar system according to Supplementary note 25 or 26, wherein

the window control means increases the window size when a position of the object is far from the transmitting antenna and the receiving antenna.

(Supplementary note 28) The radar system according to any one of Supplementary notes 25 to 27, wherein

the window control means increases the degree of overlap when a position of the object is far from the transmitting antenna and the receiving antenna.

(Supplementary note 29) The radar system according to any one of Supplementary notes 23 to 28, wherein

the measurement policy control means determines the measurement policy based on the information of the object.

(Supplementary note 30) The radar system according to Supplementary note 29, wherein

the information of the object is a position of the object.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

11, 21 Measurement policy control means
12, 22 Transmitting antenna
13, 23 Receiving antenna
14, 25 Storage means
15, 26 Window control means
16 Signal selection means
17, 24 Image generating means
27 Image updating means
10, 20, 100, 200, 300, 400, 500, 600 Radar System
101, 301 Measurement policy control unit
102 Transmitting antenna
103 Receiving antenna
104, 204, 304 Signal transmitting and receiving unit
105, 205 Recording unit
106, 306 Window control unit
107 Signal selection unit
108, 208 Image generating unit
207 Image updating unit
310, 510 Object state acquisition unit
520 External sensor
800 Object
805 Detection target
1000 CPU
1001 Storage device
1002 Memory

What is claimed is:

1. A radar system comprising:
a measurement policy control unit which determines a measurement policy relating to how a signal is to be measured,
a transmitting antenna that irradiates electromagnetic waves according to the measurement policy,
a receiving antenna that receives reflected waves of the irradiated electromagnetic waves and generates a measurement signal,
a storage unit which stores the measurement signals,
a window control unit which determines a window for selecting the measurement signals,
a signal selection unit which selects measurement signals from the storage unit based on the window, and
an image generating unit which generates a radar image from the selected measurement signals.

2. The radar system according to claim 1, further comprising
a grouping unit which groups a plurality of transmitting antennas, wherein
the storage unit stores the measurement signals for each group.

3. A radar system comprising:
a measurement policy control unit which determines a measurement policy relating to how a signal is to be measured,
a transmitting antenna that irradiates electromagnetic waves according to the measurement policy,
a receiving antenna that receives reflected waves of the irradiated electromagnetic waves and generates a measurement signal,
an image generating unit which generates a radar image from the measurement signals,
a storage unit which stores the radar images,
a window control unit which determines a window for selecting the radar image, and
an image updating unit which selects the radar image from the storage unit based on the window and generating an updated radar image based on the selected radar image.

4. The radar system according to claim 3, wherein
the image updating unit stores the updated radar image in the storage unit.

5. The radar system according to claim 4, wherein
the image updating unit generates a new updated radar image from the selected radar image and the updated radar image stored in the storage unit.

6. The radar system according to claim 3, further comprising
a grouping unit which groups a plurality of transmitting antennas, wherein
the storage unit stores the radar images for each group.

7. The radar system according to claim 1, wherein
the window control unit determines a window size and degree of overlap for determining the number of the measurement signals or the radar images and selection timing for selecting the measurement signals or the radar images, as the window.

8. The radar system according to claim 1, wherein
the measurement policy control unit determines an irradiation time interval of the electromagnetic wave, group information regarding the transmitting antenna, and an irradiation order, as the measurement policy.

9. An imaging method comprising:
determining a measurement policy relating to how a signal is to be measured,
irradiating electromagnetic waves from a transmitting antenna according to the measurement policy,
receiving reflected waves of the irradiated electromagnetic waves by a receiving antenna and generating a measurement signal,
storing the measurement signal in a storage unit,
determining a window for selecting the measurement signals,
selecting measurement signals from the storage unit based on the window, and
generating a radar image from the selected measurement signals.

10.-12. (canceled)

13. The imaging method according to claim 9, further comprising
determining a window size and degree of overlap for determining the number of the measurement signals or the radar images and selection timing for selecting the measurement signals or the radar images, as the window.

14. The imaging method according to claim 9, further comprising
determining an irradiation time interval of the electromagnetic wave, group information regarding the transmitting antenna, and an irradiation order, as the measurement policy.

15.-20. (canceled)

21. The radar system according to claim 4, further comprising
a grouping unit which groups a plurality of transmitting antennas, wherein
the storage unit stores the radar images for each group.

22. The radar system according to claim 5, further comprising
a grouping unit which groups a plurality of transmitting antennas, wherein
the storage unit stores the radar images for each group.

23. The radar system according to claim 3, wherein
the window control unit determines a window size and degree of overlap for determining the number of the measurement signals or the radar images and selection timing for selecting the measurement signals or the radar images, as the window.

24. The radar system according to claim 3, wherein
the measurement policy control unit determines an irradiation time interval of the electromagnetic wave, group information regarding the transmitting antenna, and an irradiation order, as the measurement policy.
